(19) United States
(12) Patent Application Publication
(10) Pub. No.: US 2026/0018150 A1
(43) Pub. Date: Jan. 15, 2026

(54) MULTI-AXIS CAPACITIVE TOUCH SENSING

(71) Applicant: Artiphon Inc., Nashville, TN (US)

(72) Inventors: Michael Butera, Swan Island, ME (US); Nicholas Andrew Playle, Anola (CA); Eric Christopher, Black Mountain, NC (US); Amit Shoham, Oakland, CA (US); Gregory Surges, Swannanoa, NC (US)

(21) Appl. No.: 18/771,924

(22) Filed: Jul. 12, 2024

(51) Int. Cl. G10H 1/34; G10H 1/00

(52) U.S. Cl. CPC G10H 1/344; G10H 1/0008; G10H 1/0066; G10H 2220/161; G10H 2220/271; G10H 2240/311

(57) ABSTRACT

Systems, apparatuses, methods, and techniques are described for providing improved multi-axis capacitive touch sensing. An example method includes facilitating the operation of a set of multi-axis capacitive touch sensors based on a sensor measurement phasing procedure. The example method further includes executing a hybrid velocity-noise rejection procedure that comprises determining whether a touch input has occurred with respect to a respective multi-axis capacitive touch sensor, as well as determining a velocity of the touch input. The example method further includes executing a touch input location detection procedure that comprises determining a location of the touch input and generating, based on one or more of the velocity of the touch input or the location of the touch input, a set of control signals. The example method further includes providing the set of control signals to one or more electronic devices to facilitate the control of the one or more electronic devices.

### BACKGROUND

As advancements are made with respect to the development of the hardware, software, and form factor of electronic devices, the means in which humans control and interact with said electronic devices must be adapted and improved. Conventional systems and techniques for controlling electronic devices exhibit numerous drawbacks and limitations. Furthermore, such conventional systems and techniques may preclude humans from efficiently and effectively utilizing the technological capabilities of various electronic devices.

### BRIEF DESCRIPTION OF DRAWINGS

Reference will now be made to the accompanying drawings, which are not necessarily drawn to scale. Some embodiments may include fewer or more components than those shown in the figures.

FIG. 1 illustrates an example multi-axis capacitive touch sensing system for providing multi-axis capacitive touch sensing for use in controlling an electronic device in accordance with various aspects of the present disclosure.

FIG. 2 illustrates example components of an example multi-axis capacitive touch sensing system in accordance with various aspects of the present disclosure.

FIG. 3A illustrates example user inputs associated with an example multi-axis capacitive touch sensor and an example capacitive touch bridge sensor in accordance with various aspects of the present disclosure.

FIG. 3B illustrates example sensor sample measurements taken with respect to example user inputs in accordance with various aspects of the present disclosure.

FIG. 4A illustrates an elevated view of an example electronic device that may utilize a capacitive touch sensing system in accordance with various aspects of the present disclosure.

FIG. 4B illustrates a backside view of an example electronic device that may utilize a capacitive touch sensing system in accordance with various aspects of the present disclosure.

FIG. 5 illustrates example components of an electronic device that may utilize a capacitive touch sensing system in accordance with various aspects of the present disclosure.

FIG. 6 illustrates a flowchart diagram of an example process for executing a sensor measurement phasing procedure in accordance with various aspects of the present disclosure.

FIG. 7 illustrates a flowchart diagram of an example process for providing multi-axis capacitive touch sensing for use in controlling an electronic device in accordance with various aspects of the present disclosure.

FIG. 8 illustrates a flowchart diagram of an example process for executing a hybrid velocity-noise rejection procedure in accordance with various aspects of the present disclosure.

FIG. 9 illustrates a flowchart diagram of an example process for executing a touch input location detection procedure in accordance with various aspects of the present disclosure.

### DETAILED DESCRIPTION

In the following description, reference is made to the accompanying drawings which illustrate several examples for the present disclosure. It is understood that other embodiments may be utilized and that mechanical, compositional, structural, and/or electrical operational changes may be made without departing from the spirit and scope of the present disclosure. The following detailed description is not to be taken in a limiting sense, and the scope of the embodiments of the present invention is defined only by the claims of the issued patent.

As the form factor, design, and capabilities of modern-day, consumer-grade electronic devices advance, so too must the underlying technologies used to control said electronic devices. Touchscreens, trackpads, and other sensors configured with a flat touch surface (e.g., a smooth glass or composite touch surface) can be found on myriad types of electronic devices used throughout daily life. For example, electronic devices such as smartphones, smart home devices, laptop computers, tablet computers, control pads, kiosks, and/or the like often rely on conventional capacitive touch sensors and techniques in order to provide a user with control over a respective electronic device. However, as will be described herein, such conventional touch sensors and techniques exhibit various inefficiencies and limitations. Furthermore, such conventional touch sensors and techniques may not provide sufficient control for many electronic devices requiring higher fidelity input, lower latency, and/or increased responsiveness.

A conventional capacitive sensor may consist of a copper pad constructed according to predefined dimensions and etched onto the surface of a printed circuit board (PCB). A nonconductive overlay may serve as a touch surface for the capacitive sensor and may be fabricated from various materials such as glass, acrylic, composite plastic, wood, fabric, and/or the like. Capacitive touch sensing involves measuring changes in an amount of capacitance between a capacitive sensor and the environment in which the capacitive sensor is situated in order to detect the presence of a conductor (e.g., a human finger, a stylus) on or near a touch surface associated with the capacitive sensor. In some examples, capacitive touch sensing works by applying an electric charge to a sensor at a known rate and measuring how long it takes for the sensor to charge. The presence of a conductor (e.g., a human finger) proximate to a respective capacitive sensor causes the amount of capacitance of the capacitive sensor to increase. This increase in capacitance can be measured and quantified and used as an input value to cause the operation of various hardware and/or software components associated with a corresponding electronic device.

Some conventional capacitive touch sensing systems are configured to receive input only on one axis such that any input received using such a capacitive sensor may only adjust an input value associated with a single parameter. For example, a conventional, one-dimensional (1D) capacitive touch sensing system associated with a single axis may be used as a slider configured to increase or decrease a value associated with a single parameter such as the intensity (e.g., brightness) of a light fixture, or the volume of an audio device. Such conventional, 1D capacitive touch sensing systems are limited in the number of parameters they may control such that multiple capacitive touch sensors would be required in order to adjust input values associated with multiple respective parameters.

Other conventional capacitive touch sensing systems may be two-dimensional (2D) and may be configured as a grid or matrix. Such conventional capacitive touch sensing systems may be associated with a trackpad or touchscreen of an electronic device, where an interpolation of a coordinate position associated with the touch input of a conductor (e.g., a human finger, stylus) may be used to interact with said electronic device. However, such 2D capacitive touch sensing systems require a large amount of individual capacitive sensors to make up a grid or matrix that covers an area associated with a touch surface (e.g., a trackpad of a laptop computer), thus increasing the material cost and consumption of resources. Additionally, the scan rate (e.g., sampling rate) associated with such conventional, 2D capacitive touch sensing systems is relatively slow (e.g., 50 sensor scans per second) such that the latency related to the detection and resultant interpolation of a touch input may adversely impact the responsiveness of an electronic device incorporating such a system. The latency of such conventional 2D capacitive touch sensing systems may also be adversely impacted by the limitations imposed by the required computational requirements (e.g., processing-intensive matrix multiplexing functions).

The relatively high latency and lack of responsiveness associated with conventional capacitive touch sensing systems may preclude the use of such conventional capacitive touch sensing systems in domains that require fidelity, responsiveness, expressiveness. For example, in the musical domain, it may be desirable to employ a capacitive touch sensing system in order to control one or more electronic musical instruments. However, the effect of latency and lack of responsiveness associated with conventional capacitive touch sensing systems may adversely impact the playability and expressiveness expected in a musical instrument. For example, even a small delay in the triggering of a musical note due to system latency may adversely affect the timing and/or feel of a piece of music and may inhibit a user from playing the musical instrument accurately. Additionally, while conventional capacitive touch sensing systems may be configured to determine a proximity of a conductor (e.g., a human finger) to a capacitive touch sensor, a conventional capacitive touch sensing system may not be configured to determine a velocity associated with a touch input (e.g., a touch of a human finger on a capacitive sensor). Failure to determine the velocity of a touch input may thus limit the expression and/or responsiveness of the musical instrument (e.g., the intentional variability in the perceived velocity, dynamics, impact, force, and/or the like of a particular note, string, percussive instrument and/or the like).

To solve these and other technical challenges, the present disclosure sets forth systems, methods, and apparatuses that provide improved multi-axis capacitive touch sensing. Example embodiments include a multi-axis capacitive touch sensing system that is configured to detect one or more touch inputs, proximity inputs, and/or gesture-based inputs associated with a conductor (e.g., a human finger, stylus) and determine various characteristics (e.g., velocity, surface area, location, pressure) associated with the one or more touch inputs, proximity inputs, and/or gesture-based inputs. Based upon the various characteristics associated with the one or more touch inputs, proximity inputs, and/or gesture-based inputs, the multi-axis capacitive touch sensing system may be configured to generate a set of control signals associated with a respective communications protocol. For example, the multi-axis capacitive touch sensing system may be configured to generate control signals associated with a musical instrument digital interface (MIDI) protocol (e.g., Bluetooth low energy (BLE) MIDI (BLE-MIDI), USB MIDI, MIDI 1.0, MIDI 2.0, etc.), a “digital multiplexing 512” (DMX512) protocol, and/or any suitable communications protocol used for real time or near-real time operation of one or more electronic devices.

In various embodiments, a multi-axis capacitive touch sensing system may be integrated with an electronic device (e.g., a musical instrument, an audio mixer, a MIDI device, an intelligent lighting console, a user device, a computing device, and/or the like). In some examples, a multi-axis capacitive touch sensing system may be embodied in the structural housing of a respective electronic device and may be configured to operate one or more functionalities of the respective electronic device. In other examples, the multi-axis capacitive touch sensing system may be embodied in a discrete housing separate from an electronic device (e.g., a user device, a computing device) and may be configured to control one or more functionalities of the electronic device via a conductive wire and/or a communications network (e.g., a near-field communications (NFC) network (e.g., Bluetooth), a Wi-Fi network, and/or the like).

A multi-axis capacitive touch sensing system may be configured to enable users to operate an electronic device based on various interactions including touch inputs, proximity inputs, and/or gesture-based inputs. The multi-axis capacitive touch sensing system may be configured to implement (concurrently or serially) one or more of a sensor measurement phasing procedure, a hybrid velocity-noise rejection procedure, and/or a touch input location detection procedure in order to detect, quantify, interpret, and/or otherwise analyze one or more touch inputs, proximity inputs, and/or gesture-based inputs in order to generate one or more control signals. As a result, the multi-axis capacitive touch sensing system provides numerous benefits over conventional capacitive touch sensing systems that include reducing a number of required capacitive touch sensors, reducing a number of required sub-controllers (e.g., microchip processors, control circuitries), reducing capacitive sensor noise (e.g., false triggers, sensor interference), enabling a higher sensor scanning rate, improving system latency and responsiveness (e.g., decreasing response time), as well as the ability to determine a relative velocity associated with a respective touch input.

In this regard, the multi-axis capacitive touch sensing system may employ one or more multi-axis capacitive touch sensors which provide several improvements over conventional capacitive touch sensors. For example, a respective multi-axis capacitive touch sensor comprises a set of asymmetric interleaved capacitive touch bolt sensors and a set of interleaved capacitive touch rejector sensors. Due to the unique shape of the asymmetric interleaved capacitive touch bolt sensors, fewer capacitive touch sensors are required for a given touch surface area (e.g., a play surface of an electronic musical instrument). Because the unique shape of the asymmetric interleaved capacitive touch bolt sensors necessitates fewer capacitive touch sensors, the multi-axis capacitive touch sensing system also requires fewer sub-controllers (e.g., microchip processors, control circuitries) to operate the multi-axis capacitive touch sensors. Further details related to the layout of the asymmetric interleaved capacitive touch bolt sensors will be described in more detail herein. As a result, both the resource consumption and the computational processing requirements associated with an electronic device integrated with the multi-axis capacitive touch sensing system may be reduced.

Furthermore, based on the implementation of the sensor measurement phasing procedure, the multi-axis capacitive touch sensing system may provide the benefit of reducing capacitive sensor noise (e.g., false triggers, sensor interference). During operation, a first capacitive touch sensor charged with an electrical current may emit electrical noise (e.g., electrical interference) that can potentially couple into a second capacitive touch sensor located adjacent to the first capacitive touch sensor. Such electrical noise may be interpreted by a capacitive touch sensing system as an input (e.g., a touch input) into the second capacitive touch sensor which may lead to a false trigger (e.g., a generation of an unintended control signal). As such, the sensor measurement phasing procedure may be implemented such that organized banks of sub-controllers associated with respective subsets of the multi-axis capacitive touch sensors may be activated according to a predetermined pattern. The predetermined pattern may dictate that a first subset of multi-axis capacitive touch sensors be activated separately at a different time than a second and/or third subset of multi-axis capacitive touch sensors. As such, electrical noise generated by a first active multi-axis capacitive touch sensor will not be coupled into an unintended (e.g., adjacent) multi-axis capacitive touch sensor. Further details related to the implementation of the sensor measurement phasing procedure will be described in more detail herein.

Additionally, as described herein, the multi-axis capacitive touch sensing system may execute a hybrid velocity-noise rejection procedure configured to determine whether a touch input has occurred on a respective multi-axis capacitive touch sensor. In this regard, a continuous velocity detection process operates in parallel with a noise rejection median filter with respect to a set of sensor samples generated with respect to the respective multi-axis capacitive touch sensor. The use of the hybrid velocity-noise rejection procedure provides benefits over conventional capacitive touch sensing techniques that may employ a simple noise threshold and/or noise filter, as such simple noise thresholds and/or noise filters may contribute to a sensor scanning delay (e.g., a delay of three sensor samples). Such a delay may increase latency and reduce the responsiveness of the system, which would be unacceptable for electronic devices such as electronic musical instruments. If a legitimate touch input has occurred, the multi-axis capacitive touch sensing system may determine a velocity associated with the touch input, such that the touch input and corresponding velocity be used to generate control signals associated with respective control signal types and control signal values. For example, the touch input may be used to generate a first control signal associated with a control signal type related to a first parameter (e.g., a MIDI channel voice message associated with a “note on event” associated with a particular musical note), where the velocity of the touch input may correlate to velocity value (e.g., a velocity with which the musical note should be played).

Additionally, based on the implementation of the touch input location detection procedure, the multi-axis capacitive touch sensing system may be configured to determine a precise location of a respective touch input on multiple axes within a defined boundary of a respective multi-axis capacitive touch sensor. Based on the precise location of the respective touch input, the multi-axis capacitive touch sensing system may determine a horizontal position index value and/or a vertical position index value. The horizontal position index value and/or the vertical position index value may be used to generate a second and third control signals respectively. For example, the vertical axis associated with the respective multi-axis capacitive touch sensor may be associated with a control signal type related to a second parameter (e.g., a MIDI controller change (CC) message associated with filter frequency cutoff), where the vertical position index value may correlate to a control signal value (e.g., a controller value between 0-127 associated with the MIDI CC message). Additionally, the horizontal axis associated with the respective multi-axis capacitive touch sensor may be associated with a control signal type related to a third parameter (e.g., a MIDI channel voice message associated with pitch bend), where the horizontal position index value may correlate to a control signal value (e.g., an amount of pitch bend to be applied to an active musical note).

Additionally, the touch input location detection procedure may be utilized to determine a surface area associated with the respective touch input, where the surface area may be used to generate a fourth control signal. For example, the surface area of the touch input may be used to generate a control signal associated with a control signal type related to a fourth parameter (e.g., a MIDI channel voice message associated with a “polyphonic key pressure,” also known as aftertouch), where the surface area of the touch input may correlate to a pressure value, where the pressure value may be used to augment one or more characteristics of the musical note being played as a result of the touch input. In this regard, a single touch input associated with a respective multi-axis capacitive touch sensor may generate multiple control signals of various control signal types and/or associated with various respective parameters, each of which may be associated with a respective controls signal value. For example, as described herein, a single touch input may generate four control signals based on the respective velocity, surface area, horizontal position index value, and vertical position index value associated with the single touch input.

This is provided in conjunction with other advantages, such as enabling more streamlined electronic devices (e.g., requiring a smaller installation footprint) and/or less cost and/or resources to power and/or produce (e.g., due to streamlined circuitry and/or the removal of redundant electronic components). For example, in contrast to conventional systems and/or electronic devices, example embodiments described herein eliminate the need for excess capacitive sensors and/or sub-controllers (e.g., microchip processors, control circuitries) and, thus, reduce costs, and/or resource consumption for electronic devices by removing electronic components that were previously required to detect capacitive touch inputs. As such, the example embodiments described herein provide more flexibility at a lower cost to manufacturers and/or end users (e.g., individuals, corporations, governments, etc.). Moreover, it should be appreciated that example embodiments as set forth herein solve particular technical problems, such as those identified and described above for conventional capacitive touch sensing systems. For instance, example embodiments provide techniques to, among other things, decrease latency while operating electronic devices, increase responsiveness in said electronic devices, and mitigating electrical noise interference amongst adjacent capacitive touch sensors.

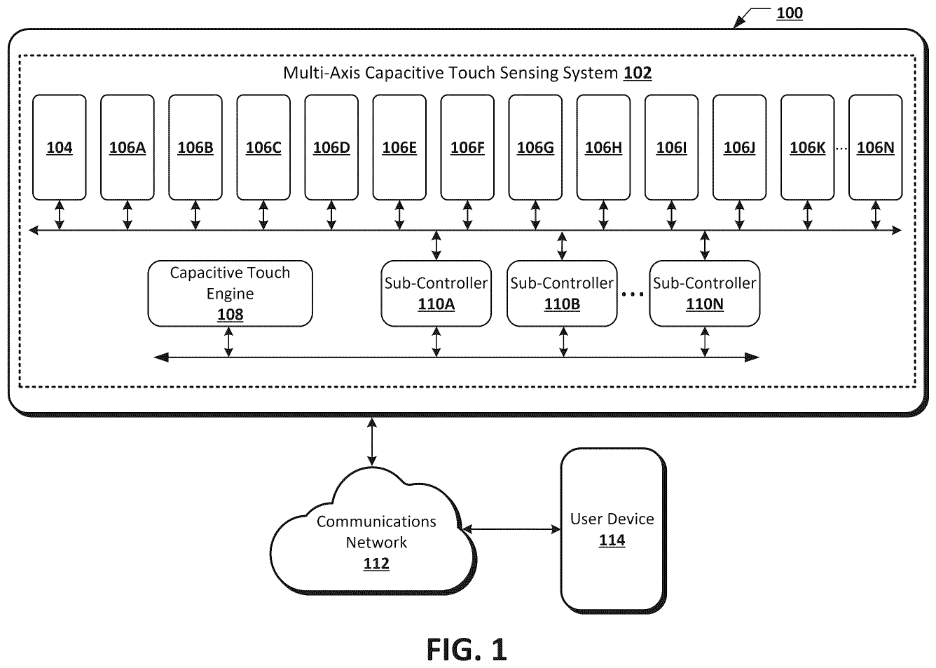

It will be appreciated that the scope of the present disclosure encompasses many potential example embodiments in addition to those described above, some of which will be described in further detail below. Now that some advantages associated with example implementations described herein have been described above in contrast with traditional systems, examples of the architecture and componentry of example embodiments will now be described below with reference to FIGS. 1-2, 3A-3B, 4A-4B, and 5-9.

FIG. 1 illustrates an example environment for utilizing multi-axis capacitive touch sensing to control an electronic device. In particular, FIG. 1 illustrates an example multi-axis capacitive touch sensing system 102 integrated with an electronic device 100 and a user device 114 in accordance with various aspects of the present disclosure. As described herein, a respective multi-axis capacitive touch sensing system 102 may be integrated with an electronic device 100 such as a musical instrument, an audio mixer, a MIDI device, an intelligent lighting console, a computing device, and/or the like. In some examples, the multi-axis capacitive touch sensing system 102 may be embodied in the structural housing of the electronic device 100 and may be configured to operate one or more functionalities of the respective electronic device 100. In other examples, the multi-axis capacitive touch sensing system 102 may be embodied in a discrete housing separate from an electronic device 100 which the multi-axis capacitive touch sensing system 102 is configured to control, and may be configured to control one or more functionalities of the electronic device 100 via a conductive wire and/or a communications network 112 (e.g., an NFC network (e.g., Bluetooth), a WiFi network, and/or the like).

Additionally or alternatively, in some examples, the multi-axis capacitive touch sensing system 102 may be embodied by a first electronic device 100 (e.g., a musical instrument, an auxiliary device) and configured to control a second electronic device such as a user device 114. A user device 114 may be a smartphone, tablet computer, laptop computer, desktop computer, and/or the like. As such, the multi-axis capacitive touch sensing system 102 may be embodied by a first electronic device 100 and configured to control one or more functionalities of a user device 114. For example, the multi-axis capacitive touch sensing system 102 may be embodied by a first electronic device 100 (e.g., a musical instrument) and may be configured to control one or more functionalities associated with a software application running on a user device 114 (e.g., a digital audio workspace (DAW), a software-based audio synthesis engine, intelligent lighting software, and/or the like). The multi-axis capacitive touch sensing system 102 may be configured to communicate with one or more user devices (e.g., user device 114) over a communications network 112. The communications network 112 may be include, without limitation, various hardware and/or software components (e.g., modems, routers, switches, access nodes, network bridges, and/or the like) configured to facilitate data transmissions according to various communications protocols including Wi-Fi, Bluetooth, ZigBee, Bluetooth Low Energy (BLE), LTE, and so forth in order facilitate the methods described herein.

As shown, the multi-axis capacitive touch sensing system 102 may include a capacitive touch bridge sensor 104, a set of one or more multi-axis capacitive touch sensors 106A-106N, a capacitive touch engine 108, and/or one or more sub-controllers 110A-110N. In the example embodiment illustrated in FIG. 1, the multi-axis capacitive touch sensing system 102 is embodied in the structural housing of the electronic device 100 and is electrically coupled with the electronic device 100 to provide a means of operating the electronic device 100. In some examples, the multi-axis capacitive touch sensing system 102 may be configured as a discrete series of circuits configured on a separate PCB than the main circuit board (e.g., a motherboard, primary PCB, and/or the like) that comprises circuitry and/or componentry for executing the processing, memory, and/or networking operations of the electronic device 100. Alternatively, in some embodiments, the multi-axis capacitive touch sensing system 102 is integrated into the main circuit board of the electronic device 100.

In some example embodiments, the multi-axis capacitive touch sensing system 102 may include one or more logical subcircuits to detect, analyze, and/or otherwise process the interaction (e.g., touch, approach) of a conductor (e.g., a human finger, a human hand, a stylus) with respect to one or more of the capacitive touch bridge sensor 104 and/or the multi-axis capacitive touch sensors 106A-106N. Additionally or alternatively, in some examples, the multi-axis capacitive touch sensing system 102 may comprise (e.g., or be integrated with) one or more of a physical switch (e.g., toggle switch, rotary switch, etc.), an electrical switch (e.g., motion sensor, photosensor, etc.), a digital (e.g., solid-state switch, MOSFET, etc.), and/or the like for turning on or off an electronic device 100. In some such examples, the multi-axis capacitive touch sensing system 102 may further comprise (e.g., or be integrated with) hardware (e.g., field-programmable gate arrays (FPGAs), application-specific integrated circuits (ASICs), and/or the like as described herein), software (e.g., operating systems, program code, and/or the like as described herein), and/or firmware (e.g., Basic Input/Output System (BIOS), and/or the like as described herein) for detecting, interpreting, and/or otherwise processing one or more user interactions (e.g., touch inputs, proximity inputs, gesture-based inputs) in order to generate various control signals used to control an electronic device 100. Additionally or alternatively, in various embodiments, the multi-axis capacitive touch sensing system 102 may comprise (or be integrated with) a microcontroller and/or a microprocessor capable of configuring one or more circuitries, components, and/or operating parameters of the multi-axis capacitive touch sensing system 102.

The capacitive touch bridge sensor 104 and the one or more multi-axis capacitive touch sensors 106A-106N are specially configured capacitive touch sensors constructed to detect one or more user interactions such as proximity inputs and/or touch inputs. A proximity input may be associated with a measurable detection of an approach of a conductor (e.g., a human finger, a stylus) that crosses a predefined proximity input threshold associated with a respective capacitive touch bridge sensor 104 or a respective multi-axis capacitive touch sensor (e.g., multi-axis capacitive touch sensor 106A). A touch input may be associated with a measurable detection of a physical touch of a conductor (e.g., a human finger, a stylus) upon a respective capacitive touch bridge sensor 104 or a respective multi-axis capacitive touch sensor (e.g., multi-axis capacitive touch sensor 106A). In various examples, the capacitive touch bridge sensor 104 and/or the one or more multi-axis capacitive touch sensors 106A-106N may be associated with one or more respective touch surfaces of an electronic device 100. Such touch surfaces may be constructed of any appropriate material including, but not limited to, glass, acrylic, composite plastic, wood, fabric, and/or the like.

In some examples, the capacitive touch engine 108 is a microcontroller unit (MCU) that is separate from, but communicatively coupled to, one or more processors associated with an electronic device 100 with which the multi-axis capacitive touch sensing system 102 is integrated and may comprise various hardware and/or software componentry configured to perform the various methods described herein. Alternatively, in other examples, the capacitive touch engine 108 may be embodied by one or more processors associated with an electronic device 100 with which the multi-axis capacitive touch sensing system 102 is integrated. The capacitive touch engine 108 may be configured to employ, direct, and/or otherwise manage the operation of the capacitive touch bridge sensor 104 and/or the multi-axis capacitive touch sensors 106A-106N. As such, the capacitive touch engine 108 may be configured to receive, retrieve, aggregate, and/or otherwise process various data related to any user interactions (e.g., touch inputs, proximity inputs, gesture-based inputs) performed with respect to the capacitive touch bridge sensor 104 and/or the multi-axis capacitive touch sensors 106A-106N.

In this regard, the capacitive touch engine 108 may be configured to manage the operation of one or more sub-controllers 110A-110N, where the one or more sub-controllers 110A-110N are configured to operate predetermined subsets of the capacitive touch bridge sensor 104 and/or the multi-axis capacitive touch sensors 106A-106N. A respective sub-controller (e.g., sub-controller 110A) may be a respective control circuit comprising various microchips, chipsets, and/or circuitry components configured to enable and/or disable the operation and/or functionality of one or more of the capacitive touch bridge sensor 104 and/or the multi-axis capacitive touch sensors 106A-106N. In this regard, the capacitive touch engine 108 may be configured to facilitate the operation of the one or more sub-controllers 110A-110N, the capacitive touch bridge sensor 104, and/or the multi-axis capacitive touch sensors 106A-106N based on the execution of a sensor measurement phasing procedure, a hybrid velocity-noise rejection procedure, and/or a touch input location detection procedure in order to perform one or more of the methods described herein.

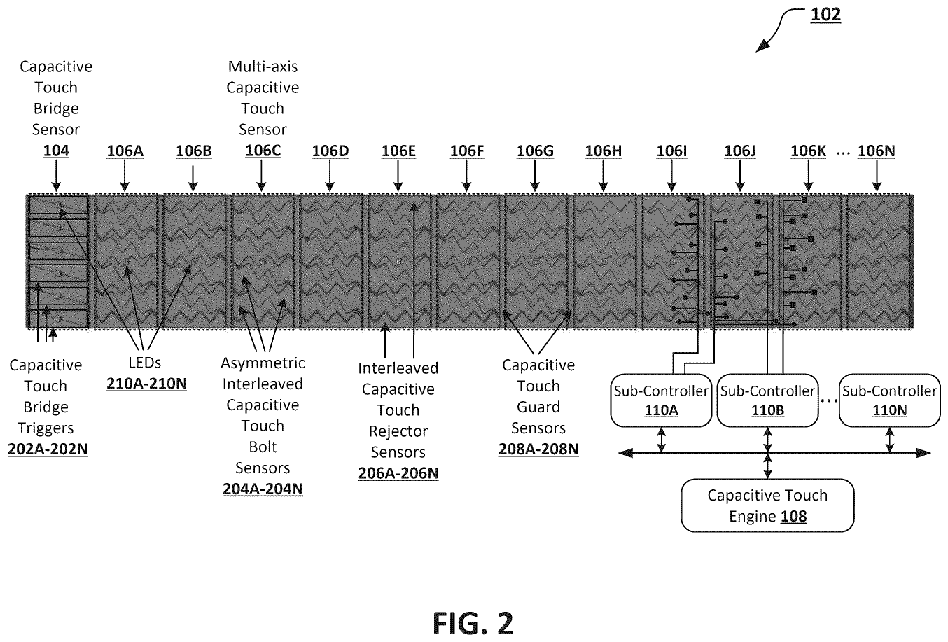

Turning now to FIG. 2, example components of an example multi-axis capacitive touch sensing system 102 are illustrated in accordance with various aspects of the present disclosure. As shown, the multi-axis capacitive touch sensing system 102 may comprise a capacitive touch bridge sensor 104, a set of one or more multi-axis capacitive touch sensors 106A-106N, a set of one or more capacitive touch guard sensors 208A-208N, a set of one or more sub-controllers 110A-110N, and/or a capacitive touch engine 108. In some examples, the capacitive touch bridge sensor 104 and/or the one or more multi-axis capacitive touch sensors 106A-106N may be associated with a respective light emitting diode (LED) (e.g., LEDs 210A-210N that may illuminate based on various user interactions (e.g., touch inputs, proximity inputs, and/or gesture-based inputs) and/or functionalities associated with the capacitive touch bridge sensor 104 and/or the one or more multi-axis capacitive touch sensors 106A-106N.

As illustrated, the capacitive touch bridge sensor 104 may comprise a set of one or more capacitive touch bridge triggers 202A-202N. The capacitive touch engine 108 may be configured to leverage a respective capacitive touch bridge trigger (e.g., capacitive bridge trigger 202A) to detect a user input (e.g., a touch input) and generate a set of control signals based on said user input. In various examples, one or more control signals of the set of control signals may be associated with a respective control signal type and/or a respective control signal value.

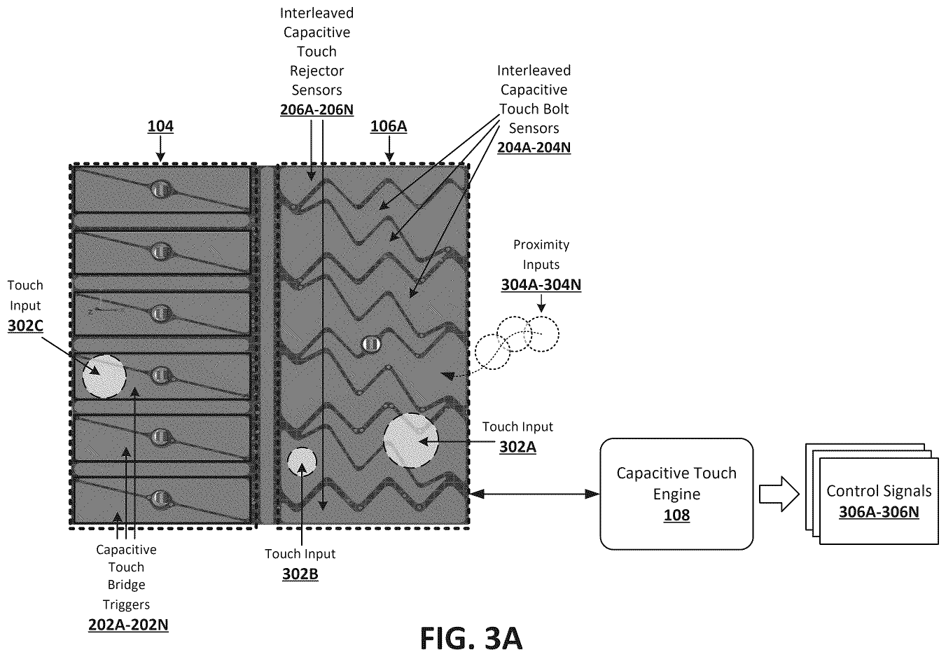

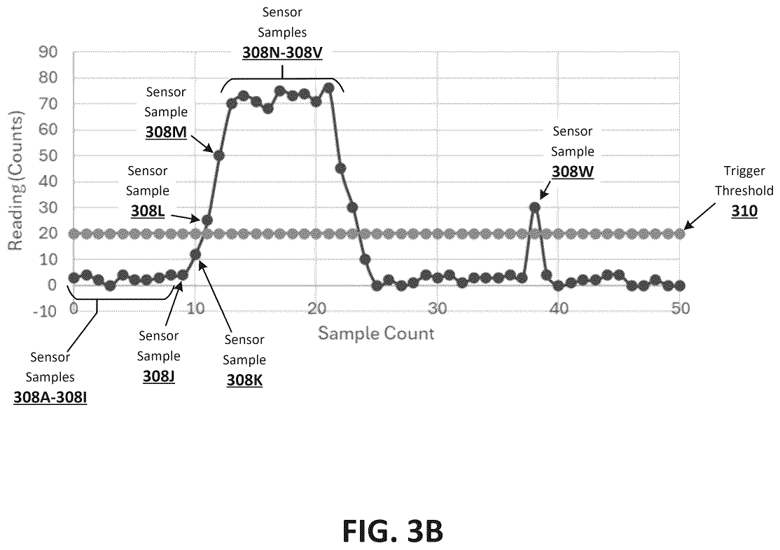

In examples in which the multi-axis capacitive touch sensing system 102 is integrated with a musical instrument, the capacitive touch bridge sensor 104 may enable a user to play a musical chord in a variety of ways. For example, due to the orientation of one or more capacitive touch bridge triggers 202A-202N, a user may be able to “strum” the capacitive touch bridge sensor 104 and trigger a sequence of musical notes (e.g., diatonic notes) associated with a particular musical chord. Additionally or alternatively, a user may be enabled to “arpeggiate” the particular musical chord by triggering individual notes (e.g., diatonic notes) of the musical chord via a series of “plucking” or “keying” type touch inputs performed with respect to one or more individual capacitive touch bridge triggers 202A-202N. Additionally, based on the location of a respective touch input within the boundaries of a respective capacitive touch bridge trigger (e.g., capacitive bridge trigger 202A), the capacitive touch engine 108 may be configured to generate additional control signals configured to modulate (e.g., augment, change, influence) an initial musical note triggered by the respective touch input. For example, a user may be enabled to drag a conductor (e.g., a human finger, a stylus) back and forth in a lateral direction across the respective capacitive touch bridge trigger (e.g., capacitive bridge trigger 202A) to add a vibrato effect to a respective note triggered based on the respective touch input. The processing of various user inputs performed with respect to the capacitive touch bridge sensor 104 will be discussed in greater detail herein with respect to FIGS. 3A-3B, 4A-4B, and 5-9.

As shown in FIG. 2, a respective multi-axis capacitive touch sensor (e.g., multi-axis capacitive touch sensor 106C) may comprise a set of one or more asymmetric interleaved capacitive touch bolt sensors 204A-204N and/or a set of one or more interleaved capacitive touch rejector sensors 206A-206. In various examples, the set of one or more asymmetric interleaved capacitive touch bolt sensors 204A-204N and/or the set of one or more interleaved capacitive touch rejector sensors 206A-206N may be composed of a suitable conductive material (e.g., copper) and etched into the structure of a respective PCB. The set of one or more asymmetric interleaved capacitive touch bolt sensors 204A-204N and/or the set of one or more interleaved capacitive touch rejector sensors 206A-206N may be configured to emit an electrical field such that various user interactions (e.g., touch inputs, proximity inputs) that cause an increase or decrease in the capacitance of a respective asymmetric interleaved capacitive touch bolt sensor (e.g., asymmetric interleaved capacitive touch bolt sensor 204A) and/or a respective interleaved capacitive touch rejector sensor (e.g., interleaved capacitive touch rejector sensor 206A may be measured by the capacitive touch engine 108 for use in generating one or more control signals.

As illustrated, the asymmetric interleaved capacitive touch bolt sensors 204A-204N are constructed in the general shape a lighting bolt such that a respective asymmetric interleaved capacitive touch bolt sensor (e.g., asymmetric interleaved capacitive touch bolt sensor 204A) comprises edges associated with a base and a tip. The base of a respective asymmetric interleaved capacitive touch bolt sensor (e.g., asymmetric interleaved capacitive touch bolt sensor 204A) is located opposite of the tip and is relatively wider than the tip. As shown, the tip of a respective asymmetric interleaved capacitive touch bolt sensor (e.g., asymmetric interleaved capacitive touch bolt sensor 204A) forms a point at the distal end of the respective asymmetric interleaved capacitive touch bolt sensor located opposite of the base. Also as illustrated, the general zig-zagged, lightning bolt-type shape of the asymmetric interleaved capacitive touch bolt sensors 204A-204N allow them to be interleaved (e.g., stacked, interlocked, positioned) with one another within the boundaries of a respective multi-axis capacitive touch sensor (e.g., multi-axis capacitive touch sensor 106C).

The geometry of the asymmetric interleaved capacitive touch bolt sensors 204A-204N directly contributes to the functionality and benefits provided by the multi-axis capacitive touch sensors 106A-106N and the multi-axis capacitive touch sensing system 102 as a whole. For example, the capacitive touch engine 108 is configured to leverage the geometry of the asymmetric interleaved capacitive touch bolt sensors 204A-204N to determine a precise location of a touch input relative to multiple axes for use in generating multiple control signals of various types. In contrast, conventional 1D capacitive touch sensing systems may be comprised of a series of individual capacitive sensors whose edges are equal in size and are characterized by a symmetric geometry. Such conventional 1D capacitive touch sensing systems may only enable a user to modulate a signal in one direction related to one parameter, much like a slider or potentiometer used to control a single parameter such as the volume of audio output or the brightness of a light fixture. Thus, such conventional 1D capacitive touch sensing systems may not be suitable for domains such as musical composition, as the conventional 1D capacitive touch sensing systems would not provide sufficient musical expression due to the limitations of the signal types, parameters, and/or modulation imposed by the geometry and configuration of said conventional, 1D capacitive touch sensing systems.

Additionally, the geometry of the asymmetric interleaved capacitive touch bolt sensors 204A-204N reduces the number of required capacitive sensors needed for a given trackpad, play surface, touchpad, and/or the like. For example, conventional 2D trackpads characterized by a grid or matrix configuration (such as those utilized in laptop computers, smartphones, and/or the like) demand relatively higher sensor pin requirements and thus necessitate relatively more sub-controllers (e.g., microchips) on a given PCB, motherboard, and/or the like. Furthermore, while some conventional matrix-based trackpads may be multiplexed in an attempt to lower sub-controller count and/or pin requirements, utilizing such multiplexing techniques may adversely impact (e.g., slow down) a sensor scanning rate associated with the conventional matrix-based trackpads. As such, conventional 2D capacitive touch sensing systems impose higher unit prices, resource consumption, and relatively slower sensor scanning rates.

The interleaved capacitive touch rejector sensors 206A-206N have a similar structure to the asymmetric interleaved capacitive touch bolt sensors 204A-204N such that one edge of a respective interleaved capacitive touch rejector sensor may be interleaved (e.g., stacked, interlocked, positioned) within one edge of a respective asymmetric interleaved capacitive touch bolt sensor. In some examples, the interleaved capacitive touch rejector sensors 206A-206N function in a same or similar manner to the asymmetric interleaved capacitive touch bolt sensors 204A-204N. However, in some examples, the functionality of one or more interleaved capacitive touch rejector sensors 206A-206N may be configured or re-configured during operation of an electronic device 100 integrated with a respective multi-axis capacitive touch sensing system 102.

For example, if the electronic device 100 is being held by a user, the user's hand and/or fingers may touch the interleaved capacitive touch rejector sensors 206A-206N during operation which may result in the generation of unwanted control signals (e.g., the triggering of an unwanted musical note based on a MIDI signal generated based on a touch input). To mitigate this potential issue, the capacitive touch engine 108 may be configured to determine whether the electronic device 100 is being held by a user during operation based on one or more values related to the rotation, roll, orientation, tilt, pitch, and/or yaw of the electronic device 100. Additionally or alternatively, in some examples, if the capacitive touch engine 108 determines that the electronic device 100 is being held by a user, the capacitive touch engine 108 may deliberately disregard any increase in the capacitance of the one or more interleaved capacitive touch rejector sensors 206A-206N. As such, the increase in the capacitance of the one or more interleaved capacitive touch rejector sensors 206A-206N may not be weighted while processing various user interactions (e.g., touch inputs, proximity inputs, gesture-based inputs) performed with respect to the corresponding multi-axis capacitive touch sensor (e.g., multi-axis capacitive touch sensor 106C) when generating control signals.

In various examples, the set of one or more capacitive touch guard sensors 208A-208N may function in a same or similar way to the interleaved capacitive touch rejector sensors 206A-206N in that the one or more capacitive touch guard sensors 208A-208N may be used to mitigate unintended user input (e.g., unintended touch input) with one or more multi-axis capacitive touch sensors 106A-106N. For example, if the capacitive touch engine 108 determines that the electronic device 100 is being held by a user, the capacitive touch engine 108 may deliberately disregard any increase in the capacitance of the one or more capacitive touch guard sensors 208A-208N. As such, the increase in the capacitance of the one or more capacitive touch guard sensors 208A-208N may not be weighted while processing various user interactions (e.g., touch inputs, proximity inputs, gesture-based inputs) performed with respect to a corresponding (e.g., adjacent) multi-axis capacitive touch sensor (e.g., multi-axis capacitive touch sensor 106C) when generating control signals.

As shown, a respective sub-controller (e.g., sub-controller 110A) may be configured to operate one or more asymmetric interleaved capacitive touch bolt sensors 204A-204N, one or more interleaved capacitive touch rejector sensors 206A-206N, and/or one or more capacitive touch guard sensors 208A-208N. In some examples, a respective sub-controller (e.g., sub-controller 110A) may be configured to operate each of the asymmetric interleaved capacitive touch sensors 204A-204N associated with a respective multi-axis capacitive touch sensor (e.g., multi-axis capacitive touch sensor 106I). Additionally or alternatively, in various examples, a respective sub-controller (e.g., sub-controller 110A) may be configured to operate one or more of the asymmetric interleaved capacitive touch bolt sensors 204A-204N associated with a plurality of multi-axis capacitive touch sensors 106A-106N. For example, as illustrated in FIG. 2, the sub-controller 110A may be configured to operate each asymmetric interleaved capacitive touch sensor associated with the multi-axis capacitive touch sensor 106I, as well as a subset of the asymmetric interleaved capacitive touch sensors associated with the multi-axis capacitive touch sensor 106J. Said differently, a first subset of the asymmetric interleaved capacitive touch bolt sensors 204A-204N of a respective multi-axis capacitive touch sensor (e.g., multi-axis capacitive touch sensor 106J) may be operated by a first sub-controller (sub-controller 110A), and a second subset of the asymmetric interleaved capacitive touch bolt sensors 204A-204N of the respective multi-axis capacitive touch sensor (e.g., multi-axis capacitive touch sensor 106J) may be operated by a second sub-controller (sub-controller 110B). Further as shown, a respective sub-controller (e.g., sub-controller 110A) may be configured to operate one or more interleaved capacitive touch rejector sensors associated with a plurality of multi-axis capacitive touch sensors (e.g., multi-axis capacitive touch sensors 106I, 106J, and/or 106K respectively).

In this regard, a one-to-one relationship between multi-axis capacitive touch sensors 106A-106N and sub-controllers 110A-110N is not required, thus providing a reduction in material cost and an efficient utilization of the components of the multi-axis capacitive touch sensing system 102. The distribution of the control of the one or more asymmetric interleaved capacitive touch sensors 204A-204N, one or more interleaved capacitive touch rejector sensors 206A-206N, and/or one or more capacitive touch guard sensors 208A-208N over the sub-controllers 110A-110N can be achieved without incurring electrical noise and/or interference between their corresponding components due in part to the implementation of a sensor measurement phasing procedure by the capacitive touch engine 108.

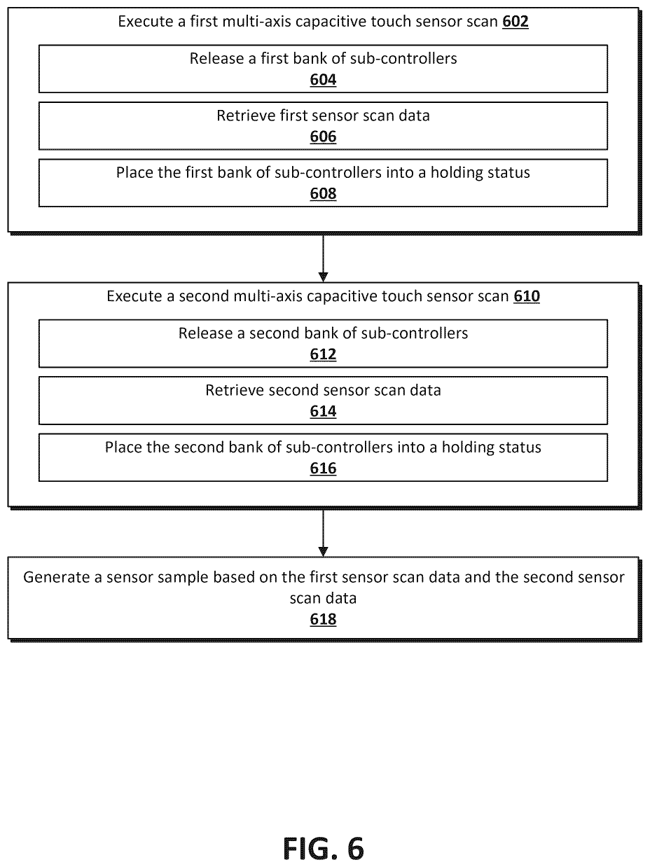

As described herein, the sensor measurement phasing procedure may be implemented such that organized banks of sub-controllers 110A-110N associated with respective subsets of the multi-axis capacitive touch sensors 106A-106N may be activated according to a predetermined pattern. The predetermined pattern may dictate that a first subset of multi-axis capacitive touch sensors 106A-106N be activated separately at a different time than a second and/or third subset of multi-axis capacitive touch sensors 106A-106N. As such, electrical noise generated by a first active multi-axis capacitive touch sensor (e.g., multi-axis capacitive touch sensor 106J) will not be coupled into an unintended (e.g., adjacent) multi-axis capacitive touch sensor (e.g., multi-axis capacitive touch sensor 106K). Further details related to the implementation of the sensor measurement phasing procedure will be described herein with reference to FIG. 6.

Turning now to FIG. 3A, example user inputs associated with an example multi-axis capacitive touch sensor and an example capacitive touch bridge sensor are illustrated in accordance with various aspects of the present disclosure. Specifically, FIG. 3A illustrates example touch inputs 302A-302C and example proximity inputs 304A-304N performed with respect to a respective capacitive touch bridge sensor 104 and a respective multi-axis capacitive touch sensor (e.g., multi-axis capacitive touch sensor 106A). As described herein, a touch input (e.g., touch input 302A) may be a measurable user interaction in which a conductor (e.g., a human finger, a stylus) is physically placed upon a respective capacitive touch bridge sensor 104 or a respective multi-axis capacitive touch sensor (e.g., multi-axis capacitive touch sensor 106A), and/or a touch surface associated with the respective capacitive touch bridge sensor or the respective multi-axis capacitive touch sensor.

As described herein, based upon the various characteristics associated with one or more user interactions (e.g., touch input 302A), the multi-axis capacitive touch sensing system 102 may be configured to generate a set of control signals (e.g., control signals 306A-306N) associated with a respective communications protocol. For example, as described herein, the multi-axis capacitive touch sensing system 102 may be configured to generate control signals associated with the MIDI protocol (e.g., MIDI 1.0, MIDI 2.0), the DMX512 protocol, and/or any suitable communications protocol used for real time or near-real time operation of an electronic device 100. In this regard, a control signal (e.g., control signal 306A) may be associated with a respective control signal type and/or a respective control signal value. A control signal type may be associated with a particular communications protocol being utilized by the multi-axis capacitive touch sensing system 102 and/or may be associated with one or more specific parameters (e.g., audio parameters, virtual instrument parameters, lighting fixture parameters, software application functionalities, computing system parameters, and/or the like).

For example, a respective control signal (e.g., control signal 306A) may be associated with a MIDI channel voice message (e.g., note on, note off, velocity, aftertouch, pitch bend, control change (CC), program change, bank select, and/or the like), MIDI system messages, MIDI system common messages, MIDI system real time messages, system exclusive messages, and/or the like. In such examples, a respective control signal value associated with a control signal (e.g., control signal 306A) configured as a MIDI message may indicate a value or a change in value related to a particular parameter being controlled (e.g., velocity, pressure, intensity, index value, and/or various control data).

Alternatively, as another example, a respective control signal (e.g., control signal 306A) may be associated with a DMX512 protocol command related to the control of one or more intelligent lighting fixtures. For example, the respective control signal (e.g., control signal 306A) may be associated with a control signal type related to the pan, tilt, hue, saturation, speed of movement, brightness, aperture, and/or like of the one or more intelligent lighting fixtures. In such examples, the control signal value associated with the respective control signal (e.g., control signal 306A) may indicate a value or a change in value associated with a particular parameter corresponding to the control signal, such as a value related to a degree of tilt, degree of rotation, an amount of saturation or hue, and/or the like.

The one or more control signals (e.g., control signals 306A-306N) generated by the multi-axis capacitive touch sensing system 102 may be utilized by one or more onboard systems associated with the electronic device 100 with which the multi-axis capacitive touch sensing system 102 is integrated. For example, an electronic device 100 may comprise an onboard music engine (e.g., a music generation software application, software-based synthesizer, and/or the like) and the one or more control signals (e.g., control signals 306A-306N) may be utilized to control one or more functionalities associated with the onboard music engine. Additionally or alternatively, the one or more control signals (e.g., control signals 306A-306N) may be configured to control one or more functionalities associated with a software application running on a separated device than the electronic device 100 (e.g., a user device 114) such as a DAW, a software-based audio synthesis engine, an intelligent lighting software application, and/or the like.

In various examples, a respective touch input (e.g., touch input 302B) may be a continuous input. For example, a conductor (e.g., a human finger, a stylus) may be held on a respective multi-axis capacitive touch sensor (e.g., multi-axis capacitive touch sensor 106A) such that the capacitive touch engine 108 generates and sustains the transmission of a respective control signal (e.g., control signal 306A). Additionally in some examples, a conductor (e.g., a human finger, a stylus) may be held and dragged vertically or horizontally across the respective multi-axis capacitive touch sensor (e.g., multi-axis capacitive touch sensor 106A). In such examples, the capacitive touch engine 108 may be configured to determine a precise location of the touch input as the touch input moves across the respective multi-axis capacitive touch sensor (e.g., multi-axis capacitive touch sensor 106A).

For example, the capacitive touch engine 108 may determine, based on an input location detection procedure, one or more of a vertical position index value and/or a horizontal position index value of the touch input, where the vertical position index value and/or the horizontal position index value are associated with the location of the touch input relative to the geometry of the respective multi-axis capacitive touch sensor (e.g., multi-axis capacitive touch sensor 106A). As such, the capacitive touch engine 108 may be configured to generate a respective control signal (e.g., control signal 306A) associated with a first touch input (e.g., an initial finger press), as well as multiple additional control signals (e.g., one or more control signals 306B-306N) associated with the vertical position index value and/or the horizontal position index value of the touch input. Furthermore, the capacitive touch engine 108 may be configured to update one or more control signal values associated with the first control signal (e.g., control signal 306A) and/or the multiple additional control signals (e.g., one or more control signals 306B-306N) as the vertical position index value and/or the horizontal position index value of the touch input change (e.g., as the conductor moves across the respective multi-axis capacitive touch sensor).

In an example in which the multi-axis capacitive touch sensing system 102 is integrated with a musical instrument, a user may trigger a musical note by pressing a touch surface associated with a respective multi-axis capacitive touch sensor and then subsequently augment (e.g., modulate, influence, alter) the musical note in multiple ways simultaneously by dragging their finger along the vertical and horizontal axes of the touch surface. For instance, dragging a finger along the vertical axis may change a value associated with a first parameter such as a filter cutoff frequency associated with the musical note, and dragging a finger along the horizontal axis may change a value associated with a second parameter such as the relative pitch associated with the musical note.

A proximity input (e.g., proximity input 304A) may be a measurable user interaction associated with the approach of a conductor (e.g., a human finger, a stylus) towards a respective capacitive touch bridge sensor 104 or a respective multi-axis capacitive touch sensor (e.g., multi-axis capacitive touch sensor 106A), and/or a touch surface associated with the respective capacitive touch bridge sensor or the respective multi-axis capacitive touch sensor. In some examples, one or more proximity inputs (e.g., proximity inputs 304A-304N) may correlate to a respective touch input (e.g., touch input 302A), such that the one or more proximity inputs are associated with the approach of the conductor that performed the respective touch input towards a touch surface associated with the respective capacitive touch bridge sensor or the respective multi-axis capacitive touch sensor.

In various examples, as part of a hybrid velocity-noise rejection procedure, the capacitive touch engine 108 may be configured to determine a velocity associated with a respective touch input (e.g., touch input 302A) based in part on information associated with one or more proximity inputs (e.g., proximity inputs 304A-304N) that correspond to the respective touch input. In examples in which a respective multi-axis capacitive touch sensing system 102 is employed in the musical domain (e.g., integrated with a musical instrument), velocity may be understood, by way of example, as how hard a person hits a key on a piano, or how hard a person plucks a string on a guitar. In order to make an expressive and responsive musical instrument, the variations of user input should predictably be transformed into musical actions, such as intensity. In this regard, and as described herein, the capacitive touch engine 108 may be configured to generate one or more control signals (e.g., control signals 306A-306N) based on one or more of a respective touch input (e.g., touch input 302A) and/or a velocity associated with the respective touch input. In examples in which a respective touch input (e.g., touch input 302A) is used to generate a control signal (e.g., control signal 306A) configured as a MIDI message, the corresponding velocity of the touch input may be interpolated as the intensity in which a user intended to “play” a note on a virtual instrument.

Turning now to FIG. 3B, the methods in which the capacitive touch engine 108 determines various user inputs (e.g., touch inputs) and their respective velocities can be visualized. As the capacitive touch engine 108 measures the capacitance of a respective multi-axis capacitive touch sensor (e.g., multi-axis capacitive touch sensor 106A), the capacitive touch engine 108 converts a value associated with the capacitance into a respective reading count index value. A respective reading count index value may be associated with a sensor sample generated by the capacitive touch engine 108 based on a series of multi-axis capacitive touch sensor scans performed as part of the sensor measurement phasing procedure. In some examples, the capacitive touch engine 108 may execute up to 500 multi-axis capacitive touch sensor scans per second, every second the multi-axis capacitive touch sensing system 102 is in operation.

As such, the x-axis (e.g., the “Sample Count” axis) illustrated in FIG. 3B indicates a set of sensor samples generated over a period of time, and the y-axis (e.g., the “Reading (Counts)” axis) indicates various reading count index values associated with the measured capacitance of a respective multi-axis capacitive touch sensor correlating to the set of sensor samples. For example, sensor samples 308J-308M associated with the steady rise in reading count index values may be associated with one or more proximity inputs (e.g., proximity inputs 304A-304N) associated with the approach of a conductor (e.g., a human finger, a stylus) towards a respective multi-axis capacitive touch sensor (e.g., multi-axis capacitive touch sensor 106A). The sensor samples 308N-308V associated with more consistent reading count index values (above the trigger threshold 310) may be associated with a touch input (e.g., touch input 302A) associated with the physical touch of a conductor (e.g., a human finger, a stylus) on a touch surface associated with the respective multi-axis capacitive touch sensor (e.g., multi-axis capacitive touch sensor 106A). As illustrated, a respective touch input (e.g., touch input 302A) may be associated with a series of sensor samples (e.g., sensor samples 308N-308V) indicating that the respective touch input lasted for a certain period of time. Using again the music domain as an example, a touch input (e.g., touch input 302A) may be relatively short (e.g., similar to a quick press of a piano key), or a touch input may be relatively long (e.g., similar to a long pull of a bow over a cello string).

In this regard, the capacitive touch engine 108 may be configured to determine whether an intended touch input (e.g., touch input 302A) has occurred with respect to a multi-axis capacitive touch sensor (e.g., multi-axis capacitive touch sensor 106A) based in part on comparing one or more reading count index values to a trigger threshold 310. As shown in FIG. 3B, at sensor sample 308K a conductor (e.g., a human finger, a stylus) is approaching but not yet touching the respective multi-axis capacitive touch sensor (e.g., multi-axis capacitive touch sensor 106A). The reading count index value associated with sensor sample 308K indicates relative increase in capacitance associated with the respective multi-axis capacitive touch sensor, but it is not yet clear that this sensor sample 308K indicates an actual user input (e.g., touch input) or noise from other nearby (possibly adjacent) multi-axis capacitive touch sensors. At sensor sample 308L, the trigger threshold 310 has been crossed and the capacitive touch engine 108 should generate a respective control signal (e.g., control signal 306A), however a reading count index value associated with a typical touch input (e.g., a full finger press) has not yet been reached.

In some examples, a reading count index value of 60+ (or 65+, or any other suitable value depending on the configuration of the respective multi-axis capacitive touch sensor) may indicate a typical touch input associated with the touch of a human finger. However, waiting for a touch input (e.g., touch input 302A) associated with a reading count index value of 60+ may cause additional latency in generating a control signal (and thus delay the triggering a musical note, or other intended command) which may be perceptible to a user. As such, it may be desirable to generate a corresponding control signal early (e.g., before a touch input associated with a reading count index value of 60+ is detected), yet still have the multi-axis capacitive touch sensing system 102 react to the velocity (or the expected velocity) of the corresponding touch input.

In this regard, the capacitive touch engine 108 may be configured to determine a respective velocity of such touch inputs by determining one or more slope values associated with various reading count index values correlating to multiple consecutive sensor samples (e.g., sensor samples 308J-308M). As such, the velocity of a respective touch input (e.g., touch input 302A) may correlate to the rate at which the slope of a line associated with various sensor samples is increasing. Based on the determined velocity, the capacitive touch engine 108 may be configured to generate a control signal (e.g., control signal 306A) prior to determining that an actual physical touch input has been made on a touch surface associated with the respective multi-axis capacitive touch sensor (e.g., multi-axis capacitive touch sensor 106A).

For example, as shown in FIG. 3B, the sensor samples 308A-308J prior to sensor sample 308K are associated with reading count index values that vary within one to two counts of each other such that the capacitive touch engine 108 may determine those particular sensor samples indicate a max slope value of two. As the conductor (e.g., a human finger) approaches the respective multi-axis capacitive touch sensor (e.g., multi-axis capacitive touch sensor 106A), the sensor samples 308J and 308K indicate a first increase of reading count index values from four to twelve respectively, indicating a slope value of eight. As the conductor (e.g., a human finger) continues to approach the respective multi-axis capacitive touch sensor (e.g., multi-axis capacitive touch sensor 106A), the sensor samples 308K and 308L indicate a second increase of reading count index values from twelve to twenty-five respectively, indicating a slope value of thirteen. Similarly, the sensor samples 308L and 308M indicate a third increase of reading count index values from twenty-five to fifty respectively, indicating a slope value of twenty-five, and the sensor samples 308M and 308N indicate a third increase of reading count index values from fifty to seventy respectively, indicating a slope value of twenty.

In various examples, the capacitive touch engine 108 may combine the reading count index values associated with consecutive sensor samples (e.g., sensor samples 308J-308M) related to a series of proximity inputs (e.g., proximity inputs 304A-304N) with different weightings to determine the velocity of a respective touch input (e.g., touch input 302A). Additionally, in some examples, the capacitive touch engine 108 can be configured according to various preferences and/or parameters such that the multi-axis capacitive touch sensors 106A-106N exhibit a desired sensitivity and/or responsiveness based on the interpolation of various user interactions (e.g., touch inputs, proximity inputs). For example the capacitive touch engine 108 may be configured to adjust the scale of how slope values associated with two or more respective reading count index values is mapped to the velocity of a respective touch input (e.g., touch input 302A). Using again the musical domain as an example, the capacitive touch engine 108 may be configured to map relatively light touch inputs more aggressively in some instances (e.g., assign relatively light touch inputs a higher velocity value, and thereby a higher intensity value). For example, if the multi-axis capacitive touch sensing system 102 is facilitating the control of an onboard music engine associated with a respective electronic device 100, mapping a light touch to relatively high velocity may be desirable when playing a virtual percussion instrument. Alternatively, it may be desirable to map a heavier touch to a relatively low velocity when playing a virtual string instrument such as virtual violin.

In addition to selectively scaling how the slope values associated with two or more respective reading count index values is mapped to the velocity of a respective touch input (e.g., touch input 302A), the capacitive touch engine 108 may be configured to adjust how many sensor samples (e.g., sensor samples 308A-308V) are analyzed when determining various slope values, as well as adjust the weights given to those sensor samples. For example, slope values associated sensor samples comprising reading count index values below the trigger threshold 310 may be give a relatively lower weight than sensor samples comprising reading count index values above the trigger threshold 310. Additionally, in various embodiments, the reading count index value associated with the trigger threshold 310 may be adjusted by the capacitive touch engine 108.

As further illustrated in FIG. 3B and in addition to determining the velocity of a respective touch input, the hybrid velocity-noise rejection procedure may be configured to mitigate various electrical noise and/or interference and prohibit such noise from generating unintended control signals based on falsely identified touch inputs. For instance, as shown, sensor sample 308W may be associated with electrical noise and/or interference. A conventional capacitive touch system utilizing a naïve approach (e.g., only relying on a trigger threshold) may be caused to generate a signal based on the reading count index value associated with sensor sample 308W. However, due to the application of a noise rejection median filter on respective sets of sensor samples during the execution of the hybrid velocity-noise rejection procedure, the capacitive touch engine 108 would disregard the sensor sample 308W rather than generate a control signal associated with a low velocity based on a falsely identified touch input. Using again the musical domain as an example, the implementation of the hybrid velocity-noise rejection procedure would ensure that the sensor sample 308W would not cause an undesired control signal to be generated (e.g., an undesired MIDI message) that may lead to the execution of an unintended musical command (e.g., the triggering of an unwanted musical note). Further details regarding the implementation of the hybrid velocity-noise rejection procedure will be provided herein with reference to FIGS. 6-9.

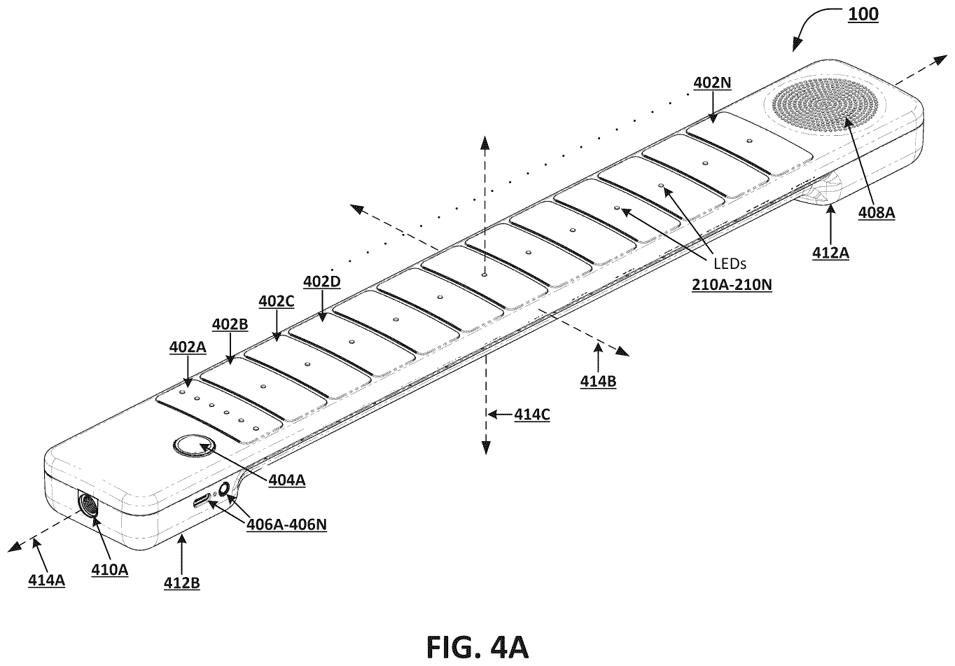

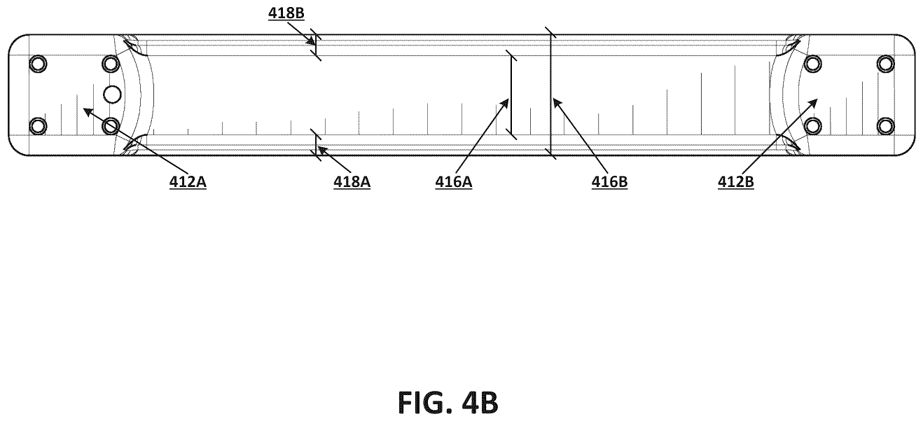

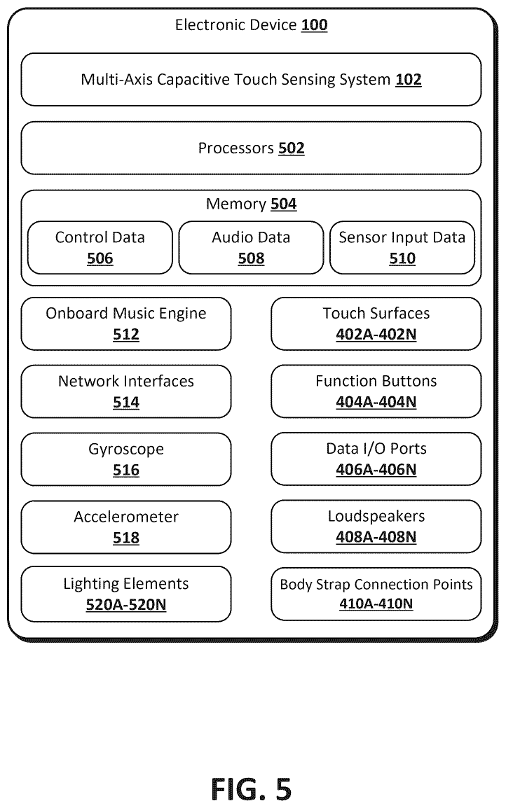

Now that various examples of a multi-axis capacitive touch sensing system 102 have been described above with reference to FIGS. 1-2 and FIGS. 3A-3B, examples of electronic devices that may benefit from a multi-axis capacitive touch sensing system 102 will now be described in further detail below with reference to FIGS. 4A-4B and FIG. 5.

FIG. 4A illustrates an elevated view of an example electronic device that may utilize a multi-axis capacitive touch sensing system 102 in accordance with various aspects of the present disclosure. Specifically, FIG. 4A illustrates an electronic device 100 configured as a musical instrument. As shown, the electronic device 100 may comprise one or more touch surfaces 402-402N, one or more function buttons 404A-404N, one or more data input/output (I/O) ports 406A-406N, one or more loudspeakers 408A-408N, one or more body strap connection points 410A-410N, and/or one or more structural supports 412A-412N.

In various examples, the one or more touch surfaces 402-402N may be constructed of a nonconductive overlay and may be fabricated from various materials such as glass, acrylic, composite plastic, wood, fabric, and/or the like. The one or more touch surfaces 402-402N may directly correspond to one or more respective capacitive touch bridge sensors (e.g., capacitive touch bridge sensor 104) and/or one or more respective multi-axis capacitive touch sensors 106A-106N. For example, as illustrated, the touch surface 402A may correspond to a respective capacitive touch bridge sensor 104. Additionally or alternatively, as shown, the touch surface 402B may correspond to a respective multi-axis capacitive touch sensor (e.g., multi-axis capacitive touch sensor 106A). As such, one or more user interactions performed with respect to the one or more touch surfaces 402A-402B (e.g., one or more touch inputs, proximity inputs, gesture-based inputs) may cause the respective capacitive touch engine 108 associated with a respective multi-axis capacitive touch sensing system 102 embodied by the electronic device 100 to generate one or more control signals (e.g., control signals 306A-306N) based on the one or more user interactions.

In various examples, the electronic device 100 may further comprise an onboard music engine such that one or more of the control signals (e.g., control signals 306A-306N) generated by the respective multi-axis capacitive touch sensing system may be configured to operate one or more functionalities associated with the onboard music engine. In some examples, the onboard music engine may be configured to generate, compose, augment, sequence, record, and/or cause playback of audio data (e.g., musical data) based on one or more control signals (e.g., control signals 306A-306N configured as MIDI messages) generated by the respective capacitive touch engine 108. In some embodiments, the onboard music engine may comprise a software-based synthesizer and/or a music generation software application configured to generate, compose, augment, sequence, record, and/or cause playback of various musical data.

In some examples, the onboard music engine may be associated with various preprogrammed data objects associated with various respective virtual instruments and/or sound effects. For example, the onboard music engine may be configured to access, manage, manipulate, configure and/or otherwise process one or more audio sample libraries, virtual instrument patches, predefined synthesis configurations, preprogrammed musical sequences (e.g., musical loops, songs, rhythms), and/or the like. As such, one or more control signals (e.g., control signals 306A-306N) generated by a respective multi-axis capacitive touch sensing system 102 may be used to operate and/or configure one or more functionalities associated with the onboard music engine.

In this regard, the electronic device may comprise one or more function buttons (e.g., function button 404A) configured to initiate and/or cause the execution of various program code commands configured to facilitate one or more operations associated with the electronic device 100 (e.g., one or more program code commands associated with the onboard music engine). In some embodiments, a respective function button (e.g., function button 404A) may be used in junction with one or more of a respective capacitive touch bridge sensor 104 and/or one or more respective multi-axis capacitive touch sensors (e.g., multi-axis capacitive touch sensor 106A-106N) to initiate and/or cause the execution of various program code commands configured to facilitate one or more operations associated with the electronic device 100.

Further in this regard, one or more of a respective capacitive touch bridge sensor 104 and/or one or more respective multi-axis capacitive touch sensors (e.g., multi-axis capacitive touch sensor 106A-106N) may be utilized in combination to generate one or more respective control signals (e.g., control signals 306A-306N). For example, a touch input performed with respect to a particular multi-axis capacitive touch sensor (e.g., multi-axis capacitive touch sensor 106A) may cause the generation of one or more control signals associated with a musical chord (e.g., an A-minor chord) to be output, voiced, and/or triggered by the onboard music engine associated with the electronic device 100. In such examples, after the touch input performed with respect to the particular multi-axis capacitive touch sensor (e.g., multi-axis capacitive touch sensor 106A) has caused the generation of the musical chord (e.g., the A-minor chord), subsequent interactions (e.g., touch inputs) with the respective capacitive touch bridge sensor may cause the generation of control signals configured to trigger various musical notes (e.g., diatonic notes) associated with the previously triggered musical chord (e.g., the A-minor chord). In this manner, a user may be enabled to arpeggiate the musical chord by triggering individual notes of the musical chord via a series of plucking, keying, or strumming type touch inputs performed with respect to one or more individual capacitive touch bridge triggers (e.g., capacitive touch bridge triggers 202A-202N) comprised in the capacitive touch bridge sensor 104.

In some examples, the electronic device 100 may further comprise one or more data input/output (I/O) ports 406A-406N. In various examples, the one or more data I/O ports 406A-406N may be configured according to one or more industry standards known in the art. For example, a respective data I/O port (e.g., data I/O port 406A) may be a universal serial bus (USB) port (e.g., USB 2.0 Type C). As another example, a respective data I/O port (e.g., data I/O port 406B) may be an audio port (e.g., a 3.5 mm headphone “jack”). The multi-axis capacitive touch sensing system 102 may be configured to cause the transmission or retrieval of various data (e.g., control signals 306A-306N) via the one or more data I/O ports 406A-406N.

Additionally, in some examples, the electronic device 100 may comprise one or more loudspeakers 408A-408N. The one or more loudspeakers 408A-408N may be configured to output various audio data (e.g., musical data) generated based on one or more control signals (e.g., control signals 306A-306N). For example, as described herein, an onboard music engine associated with the electronic device 100 may be configured to utilize the one or more control signals (e.g., control signals 306A-306N) to generate, compose, augment, sequence, record, and/or cause playback of various musical data and, as such, may cause the output of said musical data via the one or more loudspeakers 408A-408N.

Additionally, in some examples, the electronic device 100 may comprise one or more body strap connection points 410A-410N. The one or more body strap connection points 410A-410N may be threaded and/or configured to receive various hardware (e.g., a screw, button, and/or the like) associated with a body strap (e.g., a shoulder strap, a neck strap) capable of being connected to the electronic device 100 and worn by a user. In some examples, the one or more body strap connection points 410A-410N may be constructed according to one or more industry standards known in the art such that they are configured to receive various known hardware configured to attach a body strap (e.g., a shoulder strap, a neck strap) to a musical instrument. In this regard, a user may be enabled to operate the electronic device 100 while the electronic device 100 is supported from their body via a body strap connected to the one or more body strap connection points 410A-410N.

Additionally or alternatively, in various examples, a user may be enabled to operate the electronic device 100 while the electronic device 100 is supported from beneath (e.g., by a table, chair, a human lap, or any suitable support surface). In this regard, the electronic device 100 may comprise one or more structural supports (e.g., structural supports 412A-412N). In various examples, the one or more structural supports (e.g., structural supports 412A-412N) may be symmetrical in size (e.g., the outer dimensions associated with the one or more structural supports may be equal to within a predetermined manufacturing tolerance). Alternatively, in various other examples, the one or more structural supports (e.g., structural supports 412A-412N) may be of differing sizes (e.g., the outer dimensions associated with the one or more structural supports may be different). In some examples, the one or more structural supports (e.g., structural supports 412A-412N) may be configured to house one or more hardware components (e.g., magnetic motors associated with the loudspeakers 408A-408N, data input/output (I/O) ports 406A-406N, various control circuitry, and/or the like) associated with the electronic device 100. Additionally, in some examples, the one or more structural supports (e.g., structural supports 412A-412N) may comprise one or more rubber feet configured to provide a stable position and/or grip upon a respective support surface.

In various examples, a respective capacitive touch engine 108 may be configured to determine various values based on one or more axes 414A-414C associated with an electronic device 100. For example, a first axis (e.g., axis 414A) may be associated with the center of a first dimension (e.g., a width) associated with the electronic device 100. As another example, a second axis (e.g., axis 414B) may be associated with the center of a second dimension (e.g., a height) associated with the electronic device 100. As another example, a third axis (e.g., axis 414C) may be associated with the center of a third dimension (e.g., a length) associated with the electronic device 100. In this regard, the respective capacitive touch engine 108 may be configured to leverage one or more of a gyroscope and/or an accelerometer associated with the electronic device 100 in order to determine one or more values related to the rotation, roll, orientation, tilt, pitch, and/or yaw of the electronic device 100 based on the one or more axes 414A-414C. In various examples, the capacitive touch engine 108 may be configured to generate one or more control signals (e.g., control signals 306A-306N) associated with one or more values related to the rotation, roll, orientation, tilt, pitch, and/or yaw of the electronic device 100.

FIG. 4B illustrates a backside view of an example electronic device that may utilize a capacitive touch sensing system in accordance with various aspects of the present disclosure. As shown, the structural housing of the example electronic device 100 may comprise a bevel feature such that the example electronic device 100 embodies one or more grooves (e.g., 418A-418B) on either side of the electronic device 100. This effectually gives the electronic device 100 an ergonomic grip such that the electronic instrument features a first neck width (e.g., neck width 416A) and a second neck width (e.g., neck width 416B). In some examples, the first neck width (e.g., neck width 416A) may be constructed to simulate the width and feel of a neck associated with a classical string instrument such as a cello or a violin. Additionally, the second neck width (e.g., neck width 416B associated with the outer dimensions of the electronic device 100) may be constructed to simulate the width and feel of a neck associated with a guitar such as an acoustic guitar, electric guitar, or bass guitar.

Furthermore, in various examples, the one or more grooves (418A-418B) formed by the difference in width between the first neck width (e.g., neck width 416A) and the second neck width (e.g., neck width 416B) may provide an ergonomic support for the thumb, palm, and/or fingers associated with a respective user's hand. As such, users may be enabled to operate the electronic device 100 in a variety of positions, orientations, and/or with a variety of grips. For example, a user may be enabled to hold the electronic device 100 in a similar manner to the way in which a person may hold a guitar. In this regard, the user may support the electronic device 100 with a first hand (e.g., a left hand) and access one or more touch surfaces 402A-402N associated with one or more respective multi-axis capacitive touch sensors 106A-106N with the fingers of the first hand while using a second hand (e.g., a right hand) to access a touch surface (e.g., touch surface 402A) associated with a respective capacitive touch bridge sensor 104. The user may thereby “strum” the touch surface (e.g., touch surface 402A) associated with the respective capacitive touch bridge sensor 104 in a manner that simulates the strumming of guitar strings while “fretting” notes via the one or more touch surfaces 402A-402N associated with the one or more respective multi-axis capacitive touch sensors 106A-106N.

In such an example, this operational approach may be used in addition to leveraging the one or more body strap connection points 410A-410N to connect a body strap (e.g., a shoulder strap, neck strap) to the electronic device 100 and supporting the electronic device 100 via the body strap during operation. Additionally or alternatively, a user may be enabled to operate the electronic device 100 while the electronic device 100 is supported from beneath (e.g., by a table, chair, a human lap, or any suitable support surface). In this regard and as described herein, the electronic device 100 may comprise one or more structural supports (e.g., structural supports 412A-412N).

FIG. 5 illustrates example components of an electronic device 100 that may utilize a multi-axis capacitive touch sensing system 102 according to various example embodiments of the present disclosure. As described herein, the electronic device 100 may be a musical instrument, an audio mixer, a MIDI device, an intelligent lighting console, an auxiliary device, a user device, a computing device, and/or the like. The electronic device 100 is shown including processors 502 and memory 504, where the processors 502 may perform various functions associated with controlling an operation of the electronic device 100, and the memory 504 may store instructions executable by the processors 502 to perform the operations described herein. In various embodiments, the electronic device 100 may comprise and/or be integrated with a multi-axis capacitive touch sensing system 102. The electronic device 100 may further comprise one or more of an onboard music engine 512, one or more network interfaces 514, a gyroscope 516, an accelerometer 518, one or more lighting elements 520A-520N, one or more touch surfaces 402-402N, one or more function buttons 404A-404N, one or more data I/O ports 406A-406N, one or more loudspeakers 408A-408N, and/or one or more body strap connection points 410A-410N.

As used herein, a processor, such as the processors 502, may include multiple processors and/or a processor having multiple cores. Further, the processors 502 may comprise one or more cores of different types. For example, the processors 502 may include application processor units, graphic processing units, and so forth. In one implementation, the processors 502 may comprise a microcontroller and/or a microprocessor. The processors 502 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include Field-Programmable Gate Arrays (FPGAs), Application-Specific Integrated Circuits (ASICs), Application-Specific Standard Products (ASSPs), System-On-a-Chip systems (SOCs), Complex Programmable Logic Devices (CPLDs), analog comparators, pulse width modulators, counters (e.g., 16-bit counters), system clocks, and/or the like. Additionally, each of the processors 502 may possess its own local memory, which also may store program components, program data, program code, program instructions, and/or one or more operating systems.

Memory, such as the memory 504, may include volatile and nonvolatile memory, removable and non-removable media implemented in any method or technology for storage of information, such as computer-readable instructions, data structures, program component, or other data. The memory 504 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 504 may be implemented as computer-readable storage media (“CRSM”), which may be any available physical media accessible by the processors 502 to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information, and which can be accessed by the processors. The memory 504 are examples of non-transitory computer-readable media. The memory 504 may store an operating system and one or more software applications, instructions, programs, and/or data to implement the methods described herein and the functions attributed to the various systems.

The onboard music engine 512 may be comprised of hardware and/or software componentry configured to generate, compose, augment, sequence, record, and/or cause playback of audio data 508. In some examples, audio data 508 may be musical data associated with one or more musical notes, songs, musical loops, audio samples, and/or the like). In some examples, the onboard music engine 512 may be configured to generate, compose, augment, sequence, record, and/or cause playback of audio data 508 (e.g., musical data) based on various control data 506 (e.g., one or more control signals 306A-306N configured as MIDI messages) based on various sensor input data 510 (e.g., various user interactions (e.g., proximity input, touch input, and/or gesture-based input) performed with respect to the multi-axis capacitive touch sensing system 102).

In some embodiments, the onboard music engine 512 may comprise a software-based synthesizer and/or a music generation software application configured to generate, compose, augment, sequence, record, and/or cause playback of various musical data. In some examples, the onboard music engine 512 may be associated with various preprogrammed data objects associated with various respective virtual instruments and/or sound effects. For example, the onboard music engine 512 may be configure to access, manage, manipulate, configure and/or otherwise process one or more audio sample libraries, virtual instrument patches, predefined synthesis configurations, preprogrammed musical sequences (e.g., musical loops, songs, rhythms), and/or the like. As such, one or more control signals (e.g., control signals 306A-306N) generated by a respective multi-axis capacitive touch sensing system 102 may be used to operate and/or configure one or more functionalities associated with the onboard music engine 512.

Network interfaces 514 permit the electronic device 100 to communicate over one or more networks. Example network interfaces 514 include, without limitation, Wi-Fi, Bluetooth, ZigBee, BLE, LTE, and/or the like. The network interfaces 414 permit communication with remote devices, such as user devices (e.g., smartphones, computing devices), systems (e.g., cloud), and so forth. The networks may be representative of any type of communication network, including data and/or voice network, and may be implemented using wired infrastructure (e.g., cable, CAT5, fiber optic cable, etc.), a wireless infrastructure (e.g., RF, cellular, microwave, satellite, Bluetooth, etc.), and/or other connection technologies. In some instances, inbound data from may be routed through the network interfaces 514 before being directed to the processors 502, and outbound data from the processors 502 may be routed through the network interfaces 514. The network interfaces 514 may therefore receive inputs, such as data, from the processors 502, the memory 504, the onboard music engine 512, the gyroscope 516, the accelerometer 518, and so forth. For example, the network interfaces 514 may be configured to transmit data to and/or receive data from one or more network devices (e.g., switches, routers, access points, bridges, and/or the like). The network interfaces 514 may act as a conduit for data communicated between various components and the processors 502.

The gyroscope 516 may be a gyroscopic sensor configured to determine (e.g., measure) the orientation and/or rotation of the electronic device 100 along one or more axes (e.g., one or more axes 412A-412C). The gyroscope 516 may be configured to determine one or more of a rotational speed, angular velocity, and/or a rotational motion associated with the electronic device 100. The gyroscope 516 may be configured to output various values (e.g., rotation values, roll values, tilt values, yaw values) associated with the electronic device 100, where the various values may be utilized by the multi-axis capacitive touch sensing system 102 to generate control data 506 (e.g., generate various respective control signals 306A-306N).

The accelerometer 518 may be configured to determine (e.g., measure) one or more of an acceleration of motion, a vibration, a change in direction, and/or the like associated with the electronic device 100. The accelerometer 518 may be configured to output various values associated with the movement of the electronic device 100, where the various values may be utilized by the multi-axis capacitive touch sensing system 102 to generate control data 506 (e.g., generate various respective control signals 306A-306N). In some examples, the capacitive touch engine 108 of a respective multi-axis capacitive touch sensing system 102 may be configured to leverage the gyroscope 516 and/or the accelerometer 518 to determine one or more gesture-based inputs performed with respect to the electronic device 100. For example, based on the one or more values generated by the gyroscope 516 and/or the accelerometer 518, the capacitive touch engine 108 may configured to determine that a user has tilted, rotated, bumped, swung, spun, and/or otherwise manipulated the electronic device 100 along one or more axes (e.g., one or more axes 412A-412C) and in one or more respective orientations. In some examples, the capacitive touch engine 108 may be configured to generate one or more control signals (e.g., control signals 306A-306N) based on a combination of inputs (e.g., a combination of touch inputs and/or gesture-based inputs). In this regard, the capacitive touch engine 108 may be configured to cause the update (e.g., modulation) of a first control signal (e.g., control signal 306A) based on one or more gesture-based inputs performed by a user during the generation, initiation, and/or continuation of the first control signal.

The electronic device 100 also includes lighting elements 520A-520N, such as RGB LEDs and/or wLEDs (e.g., white or neutral light LEDs). The lighting elements 520A-520N may also output an indication of an operational status of the electronic device 100 (e.g., one or more of the wLEDs may flash, blink, change color, and/or the like to indicate an operational status to a user). Additionally or alternatively, in some examples, the lighting elements 520A-520N may comprise the one or more LEDs 210A-210N associated with a respective multi-axis capacitive touch sensing system 102 integrated with the electronic device 100.

Although certain components of the electronic device 100 are illustrated, it is to be understood that the electronic device 100 may include additional or alternative components. For example, the electronic device 100 may include other I/O devices (e.g., microphones, display screens), heat dissipating elements (e.g., heatsinks, fans, vents, etc.), computing components (e.g., PCBs, such as to couple the components for the multi-axis capacitive touch sensing system 102 and/or the like as described herein), antennas, ports (e.g., MIDI ports, USB ports), and so forth. In some examples, the electronic device 100 may be powered by an onboard rechargeable energy storage bank. Additionally or alternatively, the electronic device 100 may be powered by mains electricity and the onboard rechargeable energy storage bank may be employed as a backup power supply, such as if the mains electricity is unavailable and/or disconnected from the electronic device 100.

Now that various examples of electronic devices that may benefit from a multi-axis capacitive touch sensing system 102 have been described above with reference to FIGS. 4A-4B and FIG. 5, example process for providing multi-axis capacitive touch sensing for use in controlling an electronic device 100 will now be described in further detail below with reference to FIGS. 6-9.

FIGS. 6-9 illustrate a flowchart diagrams of example processes for providing multi-axis capacitive touch sensing for use in controlling an electronic device in accordance with various aspects of the present disclosure. The processes described by FIGS. 6-9 may be used for generating control signals based on detected user interactions (e.g., proximity inputs, touch inputs, gesture-based inputs) performed with respect to a multi-axis capacitive touch sensing system 102. In various embodiments, the operations of the processes described by FIGS. 6-9 may be facilitated and/or executed by a multi-axis capacitive touch sensing system 102 integrated with an electronic device 100. Additionally or alternatively, in some examples, the operations of the processes described by FIGS. 6-9 may represent a series of instructions comprising computer readable machine code executable by a processing unit of one or more computing devices described herein (e.g., electronic device 100, a user device 114, and/or any other computing device), although various operations may also be implemented in, or using, hardware (e.g., circuitry and/or componentry of an example electronic device 100 and/or an example multi-axis capacitive touch sensing system 102. In some examples, the computer readable machine code may be comprised of instructions selected from a native instruction set of at least one processor and/or an operating system of the electronic device 100. In some examples, the processes described by FIGS. 6-9 may be performed by one or more computing systems comprising the electronic device 100 and/or a multi-axis capacitive touch sensing system 102.

FIG. 6 illustrates a flowchart diagram of an example process for executing a sensor measurement phasing procedure in accordance with various aspects of the present disclosure. As described herein, the sensor measurement phasing procedure may be implemented such that organized banks of sub-controllers 110A-110N associated with respective subsets of multi-axis capacitive touch sensors 106A-106N may be activated according to a predetermined pattern. The predetermined pattern may dictate that a first subset of multi-axis capacitive touch sensors be activated separately at a different time than a second and/or third subset of multi-axis capacitive touch sensors.

In some examples, the operations described with reference to FIG. 6 may be performed subsequent to a calibration procedure associated with the respective multi-axis capacitive touch sensing system 102. In various examples, the calibration procedure may be executed by a capacitive touch engine 108 upon the powerup of an electronic device 100 integrated with the respective multi-axis capacitive touch sensing system. The calibration procedure may be configured to mitigate various irregularities associated with one or more touch surfaces (e.g., touch surfaces 402A-402N) of an electronic device 100 integrated with the respective multi-axis capacitive touch sensing system. Additionally or alternatively, the calibration procedure may be configured to tune one or more of a capacitive touch bridge sensor 104 and/or one or more multi-axis capacitive touch sensors 106A-106N such that they are active in a known acceptable sensor value range. For example, the capacitive touch engine 108 may cause the one or more of a capacitive touch bridge sensor 104 and/or the one or more multi-axis capacitive touch sensors 106A-106N to be charged to a known acceptable level (e.g., a known baseline of charge) that will not lead to unwanted electrical noise and/or interference.

As shown in FIG. 6, the process may begin at operation 602 where the capacitive touch engine 108 may be configured to execute a first multi-axis capacitive touch sensor scan. The first multi-axis capacitive touch sensor scan may be a process in which a subset of multi-axis capacitive touch sensors 106A-106N are evaluated to determine whether a measurable change (e.g., an increase or decrease) in an amount of capacitance has occurred. In this regard, and at operation 604, the capacitive touch engine 108 may be configured to “release” (e.g., activate) a first bank (e.g., subset) of sub-controllers 110A-110N. In various examples, the first bank of sub-controllers 110A-110N may be configured to operate a first subset of multi-axis capacitive touch sensors 106A-106N associated with a respective multi-axis capacitive touch sensing system 102.

The process may continue at operation 606, where the capacitive touch engine 108 may be configured to retrieve first sensor scan data. In various examples, the first sensor scan data may be data related to an amount of capacitance associated with a first multi-axis capacitive touch sensor (e.g., multi-axis capacitive touch sensor 106J). Additionally or alternatively, the first sensor scan data may comprise data related to an amount of capacitance associated with a first subset of asymmetric interleaved capacitive touch bolt sensors 204A-204N associated with the first multi-axis capacitive touch sensor (e.g., multi-axis capacitive touch sensor 106J), where the first multi-axis capacitive touch sensor is operated in part by a first sub-controller (e.g., sub-controller 110A) of the first bank of sub-controllers 110A-110N. Additionally or alternatively, the first sensor scan data may comprise data related to an amount of capacitance associated with one or more interleaved capacitive touch rejector sensors 206A-206N associated with the first multi-axis capacitive touch sensor (e.g., multi-axis capacitive touch sensor 106J). In various examples, the first sensor scan data may be used to generate one or more reading count index values associated with the first multi-axis capacitive touch sensor (e.g., multi-axis capacitive touch sensor 106J).

The process may continue at operation 608, where the capacitive touch engine 108 may be configured to place the first bank of sub-controllers 110A-110N into a holding status. Once the first sensor scan data is retrieved by the capacitive touch engine 108, the capacitive touch engine 108 may be configured cause the first bank of sub-controllers 110A-110N to enter a holding status so that the first subset of asymmetric interleaved capacitive touch bolt sensors 204A-204N associated with the first multi-axis capacitive touch sensor (e.g., multi-axis capacitive touch sensor 106J) does not cause electrical noise and/or interference to be coupled into another (e.g., adjacent) multi-axis capacitive touch sensor (e.g., multi-axis capacitive touch sensor 106K). In various examples, once the one or more multi-axis capacitive touch sensors 106A-106N associated with the first bank of sub-controllers 110A-110N have been scanned and the first sensor scan data is retrieved, the one or more corresponding multi-axis capacitive touch sensors 106A-106N may discharge any stored electrical energy. Additionally, the first bank of sub-controllers 110A-110N may be configured to maintain the one or more multi-axis capacitive touch sensors 106A-106N in a discharged state until such a time as the first bank of sub-controllers 110A-110N are released (e.g., activated) again to execute a subsequent multi-axis capacitive touch sensor scan according to the sensor measurement phasing procedure.

Furthermore, placing the first bank of sub-controllers 110A-110N into a holding status also mitigates the potential for the first subset of asymmetric interleaved capacitive touch bolt sensors 204A-204N associated with the first multi-axis capacitive touch sensor (e.g., multi-axis capacitive touch sensor 106J) to cause electrical noise and/or interference to couple into a second subset of asymmetric interleaved capacitive touch bolt sensors 204A-204N associated with the first multi-axis capacitive touch sensor once they become active.

The process may continue at operation 610, where the capacitive touch engine 108 may be configured to execute a second multi-axis capacitive touch sensor scan. The second multi-axis capacitive touch sensor scan may be a process in which a subset of multi-axis capacitive touch sensors 106A-106N are evaluated to determine whether a measurable change (e.g., an increase or decrease) in an amount of capacitance has occurred. In this regard, and at operation 612, the capacitive touch engine 108 may be configured to release (e.g., activate) a second bank (e.g., subset) of sub-controllers 110A-110N. In various examples, the second bank of sub-controllers 110A-110N may be configured to operate a second subset of multi-axis capacitive touch sensors 106A-106N associated with the respective multi-axis capacitive touch sensing system 102. However, as described herein, because two sub-controllers (e.g., sub-controllers 110A and 110B) may both operate one or more asymmetric interleaved capacitive touch bolt sensors 204A-204N associated with a respective multi-axis capacitive touch sensor, the first multi-axis capacitive touch sensor (e.g., multi-axis capacitive touch sensor 106J) may be comprised in both the first and second subsets of multi-axis capacitive touch sensors 106A-106N.

The process may continue at operation 614, where the capacitive touch engine 108 may be configured to retrieve second sensor scan data. In various examples, second sensor scan data may comprise data related to an amount of capacitance associated with a second subset of asymmetric interleaved capacitive touch bolt sensors 204A-204N associated with the first multi-axis capacitive touch sensor (e.g., multi-axis capacitive touch sensor 106J), where the first multi-axis capacitive touch sensor is operated in part by a second sub-controller (e.g., sub-controller 110B) of the first bank of sub-controllers 110A-110N. Additionally or alternatively, the second sensor scan data may comprise data related to an amount of capacitance associated with one or more interleaved capacitive touch rejector sensors 206A-206N associated with the first multi-axis capacitive touch sensor (e.g., multi-axis capacitive touch sensor 106J). In various examples, the second sensor scan data may be used to generate one or more reading count index values associated with the first multi-axis capacitive touch sensor (e.g., multi-axis capacitive touch sensor 106J).

The process may continue at operation 616, where the capacitive touch engine 108 may be configured to place the second bank of sub-controllers 110A-110N into a holding status. Once the second sensor scan data is retrieved by the capacitive touch engine 108, the capacitive touch engine 108 may be configured cause the second bank of sub-controllers 110A-110N to enter a holding status so that the second subset of asymmetric interleaved capacitive touch bolt sensors 204A-204N associated with the first multi-axis capacitive touch sensor (e.g., multi-axis capacitive touch sensor 106J) does not cause electrical noise and/or interference to be coupled into another (e.g., adjacent) multi-axis capacitive touch sensor (e.g., multi-axis capacitive touch sensor 106I). In various examples, once the one or more multi-axis capacitive touch sensors 106A-106N associated with the second bank of sub-controllers 110A-110N have been scanned and the second sensor scan data is retrieved, the one or more corresponding multi-axis capacitive touch sensors 106A-106N may discharge any stored electrical energy. Additionally, the second bank of sub-controllers 110A-110N may be configured to maintain the one or more multi-axis capacitive touch sensors 106A-106N in a discharged state until such a time as the second bank of sub-controllers 110A-110N are released (e.g., activated) again to execute a subsequent multi-axis capacitive touch sensor scan according to the sensor measurement phasing procedure.

Furthermore, placing the second bank of sub-controllers 110A-110N into a holding status also mitigates the potential for the second subset of asymmetric interleaved capacitive touch bolt sensors 204A-204N associated with the first multi-axis capacitive touch sensor (e.g., multi-axis capacitive touch sensor 106J) to cause electrical noise and/or interference to couple into the first subset of asymmetric interleaved capacitive touch bolt sensors 204A-204N associated with the first multi-axis capacitive touch sensor once they become active.

The process may continue at operation 618, where the capacitive touch engine 108 may be configured to generate a sensor sample based on the first sensor scan data and the second sensor scan data. In some examples, the sensor sample may be a first sensor sample associated with a set of sensor samples generated with respect to the first multi-axis capacitive touch sensor (e.g., multi-axis capacitive touch sensor 106J). In examples in which the first sensor scan data is associated with a first subset of asymmetric interleaved capacitive touch bolt sensors 204A-204N of a respective multi-axis capacitive touch sensor (e.g., multi-axis capacitive touch sensor 106J), and the second sensor scan data is associated with a second subset of asymmetric interleaved capacitive touch bolt sensors 204A-204N of the respective multi-axis capacitive touch sensor, the capacitive touch engine 108 may be configured to “stitch” (e.g., combine, aggregate, compile, etc.) the first sensor scan data and the second sensor scan data such the resultant sensor sample is associated with the respective multi-axis capacitive touch sensor as a whole.

Additionally or alternatively, in various examples, the capacitive touch engine 108 may be configured to initiate the execution of the second multi-axis capacitive touch sensor scan (e.g., as described with reference to operation 610) at a time in which the first sensor scan data is being received and/or retrieved (e.g., during operation 608). As such, the first sensor scan data may be processed by the capacitive touch engine 108 in parallel with one or more steps of the operation 610. In some such examples, the latency associated with the multi-axis capacitive touch sensing system 102 be further reduced as a result.

Furthermore, in some examples, a respective multi-axis capacitive touch sensing system 102 may be configured such that the capacitive touch engine 108 implements the sensor measurement phasing procedure with more than two banks of sub-controllers 110A-110N. In such examples, a third multi-axis capacitive touch sensor scan associated with a third bank of sub-controllers 110A-110N may be executed after completion of the second multi-axis capacitive touch sensor scan (e.g., subsequent to complete of operation 616), and so on until each of the banks of sub-controllers 110A-110N have been released, scanned, and subsequently placed into a holding status. In such examples, a respective sensor sample may be generated based on first sensor scan data, second sensor scan data, and third sensor scan data (e.g., relative to the number of banks of sub-controllers 110A-110N).

One advantage provided by this sensor measurement phasing procedure is that the effective scanning frequency associated with a respective multi-axis capacitive touch sensing system 102 may be reduced by the number of banks of sub-controllers 110A-110N that are utilized. As such, utilizing two banks of sub-controllers 110A-110N may yield an effective scan half of that of a system employing one bank of sub-controllers 110A-110N, whereas utilizing three banks of sub-controllers 110A-110N may yield an effective scan one-third of that of a system employing one bank of sub-controllers 110A-110N. In this regard, in some examples, the multi-axis capacitive touch sensing system 102 may be configured such that any suitable number of banks of sub-controllers 110A-110N may be employed during the execution of the sensor measurement phasing procedure.

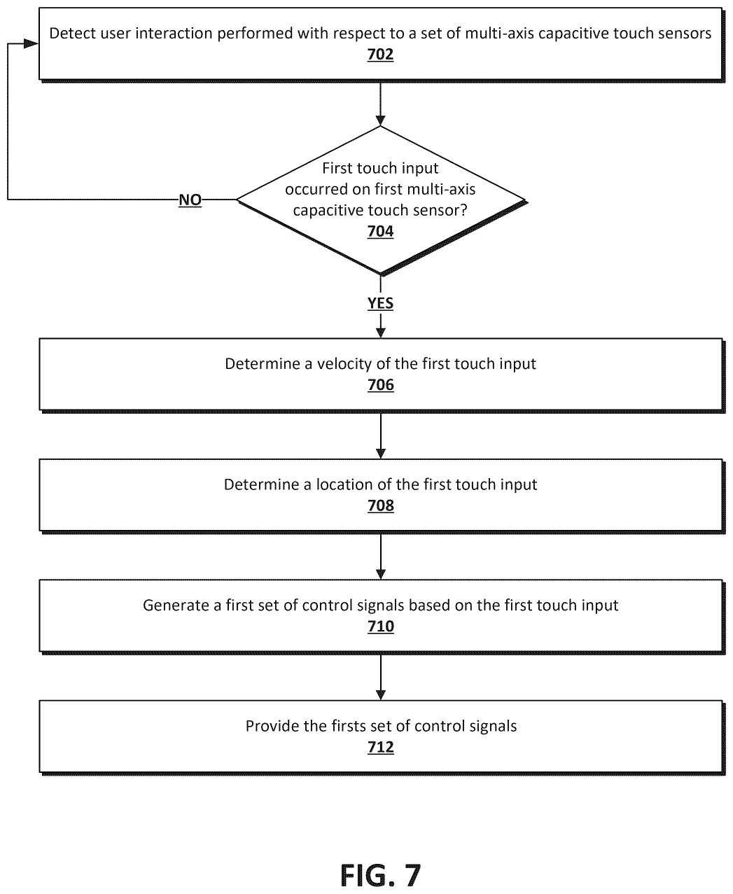

Turning now to FIG. 7, FIG. 7 illustrates a flowchart diagram of an example process for providing multi-axis capacitive touch sensing for use in controlling an electronic device 100 in accordance with various aspects of the present disclosure.

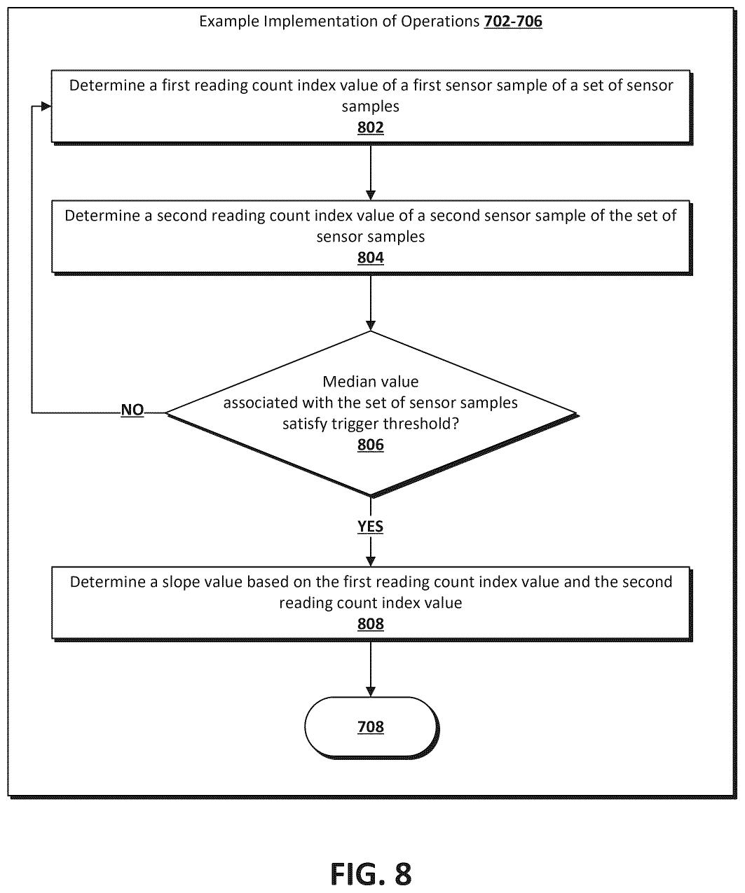

As shown in FIG. 7, the process may begin at operation 702 where the capacitive touch engine 108 may be configured to detect user interactions (e.g., touch input, proximity input) performed with respect to a set of multi-axis capacitive touch sensors 106A-106N. At operation 704, the capacitive touch engine 108 may be configured to determine whether a first touch input (e.g., touch input 302A) occurred on a first multi-axis capacitive touch sensor (e.g., multi-axis capacitive touch sensor 106J). If a first touch input (e.g., touch input 302A) has occurred, the process may continue at operation 706, where the capacitive touch engine 108 may be configured to determine a velocity of the first touch input. In some examples, operations 702-706 may be associated with the execution of a hybrid velocity-noise rejection procedure, examples implementations of which will be described in greater detail with reference to FIG. 8.

Turning briefly to FIG. 8, the process associated with the hybrid velocity-noise rejection procedure may begin at operation 802, where the capacitive touch engine 108 may be configured to determine a first reading count index value of a first sensor sample (e.g., sensor sample 308K) of a set of sensor samples generated with respect to a first multi-axis capacitive touch sensor (e.g., multi-axis capacitive touch sensor 106J). As described herein, the first reading count index value may correlate to a first amount of capacitance of the first multi-axis capacitive touch sensor (e.g., multi-axis capacitive touch sensor 106J).

The process may continue at operation 804, where the capacitive touch engine 108 may be configured to determine a second reading count index value of a second sensor sample (e.g., sensor sample 308L) of the set of sensor samples generated with respect to the first multi-axis capacitive touch sensor (e.g., multi-axis capacitive touch sensor 106J). As described herein, the second reading count index value may correlate to a second amount of capacitance (e.g., an increased amount of capacitance) of the first multi-axis capacitive touch sensor (e.g., multi-axis capacitive touch sensor 106J).

The process may continue at operation 806, where the capacitive touch engine 108 may be configured to determine whether a median value associated with the set of sensor samples satisfies a predetermined trigger threshold (e.g., trigger threshold 310). In some examples, the execution of operation 806 may be associated with the application of a noise rejection median filter on a set of sensor samples generated with respect to the first multi-axis capacitive touch sensor (e.g., multi-axis capacitive touch sensor 106J). In various examples, the noise rejection median filter may be configured to evaluate a predetermined number of previously generated sensor samples (e.g., five sensor samples, seven sensor samples, and/or any suitable number) in order to determine whether reading count index values associated with the median of the predetermined number of sensor samples satisfies the trigger threshold (e.g., trigger threshold 310). As new sensor samples are generated, the capacitive touch engine 108 may update the predetermined number of previously generated sensor samples to include the new sensor samples. As such, the set of sensor samples may function as a sliding window such that the noise rejection median filter continuously evaluates the changes in reading count index values associated with sensor samples generated over time.

If it is determined that the median value associated with the set of sensor samples satisfies the predetermined trigger threshold (e.g., trigger threshold 310), the process may continue at operation 808, where the capacitive touch engine 108 may be configured to determine a slope value based on the first reading count index value and the second reading count index value. As described herein, the capacitive touch engine 108 may be configured to determine a respective velocity of a touch input (e.g., touch input 302A) by determining one or more slope values associated with various reading count index values correlating to multiple consecutive sensor samples (e.g., sensor samples 308J-308M). As such, the velocity of a respective touch input (e.g., touch input 302A) may correlate to the rate at which the slope of a line associated with various sensor samples is increasing. In some examples, based on the determined velocity, the capacitive touch engine 108 may be configured to generate a control signal (e.g., control signal 306A) prior to determining that an actual physical touch input has been made on a touch surface associated with the respective multi-axis capacitive touch sensor (e.g., multi-axis capacitive touch sensor 106A).

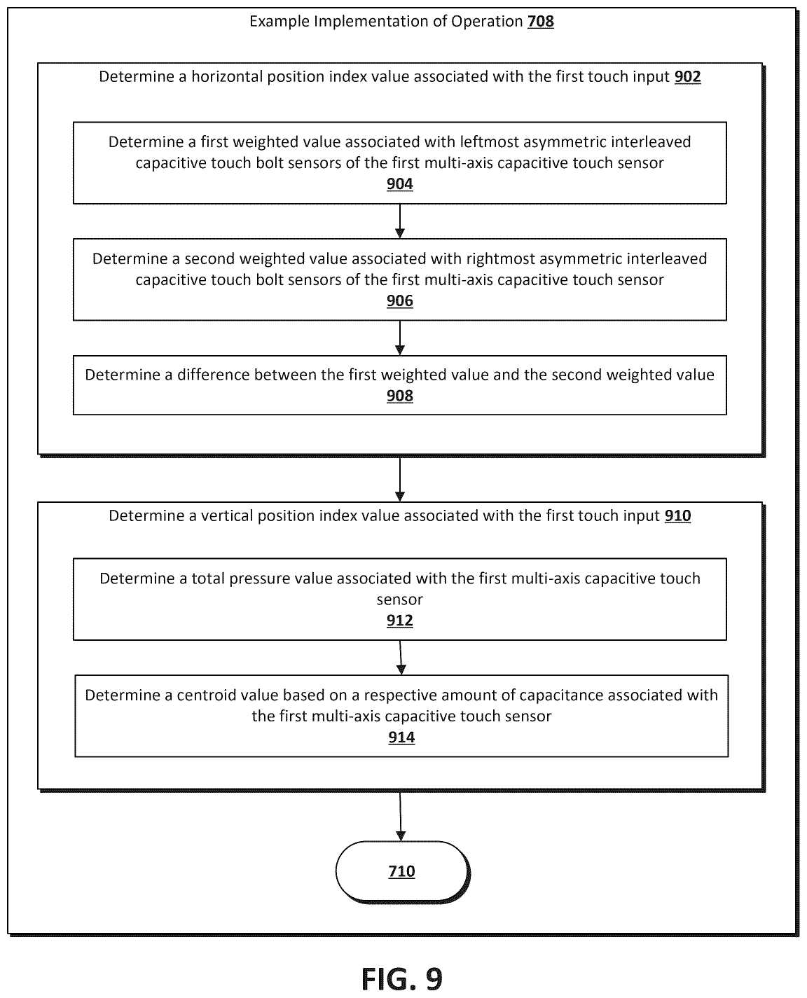

Returning now to FIG. 7, the process may continue at operation 708, where the capacitive touch engine 108 may be configured to determine a location of the first touch input (e.g., touch input 302A). In some examples, the location of the first touch input may be determined based on the execution of a touch input location detection procedure executed by the capacitive touch engine 108, examples implementations of which will be described in greater detail with reference to FIG. 9.

Turning briefly to FIG. 9, the process associated with the touch input location detection procedure may begin at operation 902, where the capacitive touch engine 108 may be configured to determine a horizontal position index value associated with the first touch input (e.g., touch input 302A). The horizontal position index value may be comprised within the first multi-axis capacitive touch sensor (e.g., multi-axis capacitive touch sensor 106J), where determining the horizontal position index value may, as shown in operation 904, cause the capacitive touch engine 108 to determine a first weighted value associated with the leftmost asymmetric interleaved capacitive touch bolt sensors 204A-204N of the first multi-axis capacitive touch sensor. In various examples, the leftmost asymmetric interleaved capacitive touch bolt sensors 204A-204N may be asymmetric interleaved capacitive touch bolt sensors whose base is oriented towards the left side of the first multi-axis capacitive touch sensor (e.g., multi-axis capacitive touch sensor 106J).

The process may continue at operation 906, where the capacitive touch engine 108 may be configured to determine a second weighted value associated with the rightmost asymmetric interleaved capacitive touch bolt sensors 204A-204N of the first multi-axis capacitive touch sensor (e.g., multi-axis capacitive touch sensor 106J). In various examples, the rightmost asymmetric interleaved capacitive touch bolt sensors 204A-204N may be asymmetric interleaved capacitive touch bolt sensors whose base is oriented towards the right side of the first multi-axis capacitive touch sensor (e.g., multi-axis capacitive touch sensor 106J). Furthermore, in some examples, the capacitive touch engine 108 may be configured to determine the left and right sides of the first multi-axis capacitive touch sensor (e.g., multi-axis capacitive touch sensor 106J) based on the orientation of the electronic device 100 integrated with the corresponding multi-axis capacitive touch sensing system 102.

The process may continue at operation 908, where the capacitive touch engine 108 may be configured to determine a difference between the first weighted value and the second weighted value. In some examples, the horizontal position index value may be determined based on the difference computed between the first weighted value and the second weighted value.

The process may continue at operation 910, where the capacitive touch engine 108 may be configured to determine a vertical position index value associated with the first touch input (e.g., touch input 302A). The vertical position index value may be comprised within the first multi-axis capacitive touch sensor (e.g., multi-axis capacitive touch sensor 106J), where determining the vertical position index value may, as shown in operation 912, cause the capacitive touch engine 108 to determine a total pressure value associated with the first multi-axis capacitive touch sensor. The total pressure value may be associated with the set of asymmetric interleaved capacitive touch bolt sensors 204A-204N and/or the set of interleaved capacitive touch rejector sensors 206A-206N, where the total pressure value is associated with a total amount of capacitance associated with the set of asymmetric interleaved capacitive touch bolt sensors 204A-204N and the set of interleaved capacitive touch rejector sensors 206A-206N.

The process may continue at operation 914, where the capacitive touch engine 108 may be configured to determine a centroid value based on a respective amount of capacitance associated with the first multi-axis capacitive touch sensor (e.g., multi-axis capacitive touch sensor 106J). In some examples, the centroid value may be generated based on the respective amount of capacitance associated with each asymmetric interleaved capacitive touch bolt sensor of the set of asymmetric interleaved capacitive touch bolt sensors 204A-204N and each interleaved capacitive touch rejector sensor of the set of interleaved capacitive touch rejector sensors 206A-206N. In various examples, the capacitive touch engine 108 may be configured to determine the vertical position index value based on one or more of the total pressure value and/or the centroid value.

Furthermore, in some examples, the capacitive touch engine 108 may generate the vertical position index value and/or a horizontal position index value based on the respective geometry associated with each asymmetric interleaved capacitive touch bolt sensor of the set of asymmetric interleaved capacitive touch bolt sensors 204A-204N. For example, as the width of a respective asymmetric interleaved capacitive touch bolt sensor (e.g., asymmetric interleaved capacitive touch bolt sensor 204A) is wider at its base and tapers towards its point, the capacitive touch engine 108 may be configured to determine the location (e.g., the horizontal and/or vertical position index value) of a touch input (e.g., touch input 302B) based on a relative amount of capacitance associated with the respective asymmetric interleaved capacitive touch bolt sensor.

Additionally or alternatively, the capacitive touch engine 108 may be configured to evaluate two or more adjacent asymmetric interleaved capacitive touch bolt sensors 204A-204N to determine the location of respective touch input (e.g., touch input 302A). For example, as shown in FIG. 3A, the touch input 302A is positioned mainly on the wider portion of a middle asymmetric interleaved capacitive touch bolt sensor of three adjacent asymmetric interleaved capacitive touch bolt sensors 204A-204N. As shown, the touch input 302A barely touches the asymmetric interleaved capacitive touch bolt sensors 204A-204N above and below the middle asymmetric interleaved capacitive touch bolt sensor. As such, the capacitive touch engine 108 may determine from evaluating the increased capacitance of the asymmetric interleaved capacitive touch bolt sensors 204A-204N associated with the touch input 302A that the touch input 302A is located to the right of center and may generate one or more control signals (e.g., control signals 306-306N) accordingly.

Returning now to FIG. 7, the process may continue at operation 710, where the capacitive touch engine 108 may be configured to generate a first set of control signals based on the first touch input. For example, as described herein, the capacitive touch engine 108 may be configured to generate one or more respective control signals (e.g., control signals 306A-306N) based on a detected touch input (e.g., touch input 302A), the determined velocity of the touch input, and/or the location (e.g., a horizontal and/or vertical position index value) of the touch input on a respective multi-axis capacitive touch sensor (e.g., multi-axis capacitive touch sensor 106J) or a respective capacitive touch bridge sensor (e.g., capacitive touch bridge sensor 104).

As further described herein, in some examples, the capacitive touch engine 108 may be configured to generate one or more control signals (e.g., control signals 306A-306N) based on a combination of inputs (e.g., a combination of touch inputs and/or gesture-based inputs). In this regard, the capacitive touch engine 108 may be configured to cause the update (e.g., modulation) of a first control signal (e.g., control signal 306A) based on one or more gesture-based inputs performed by a user during the generation, initiation, and/or continuation of the first control signal. Additionally or alternatively, as described herein, the capacitive touch engine 108 may be configured to generate one or more control signals (e.g., control signals 306A-306N) based on one or more values determined based on the rotation, roll, orientation, tilt, pitch, and/or yaw of the electronic device 100 embodying the multi-axis capacitive touch sensing system 102.

The process may continue at operation 712, where the capacitive touch engine 108 may be configured to provide the first set of control signals. For example, as described herein, the capacitive touch engine 108 may be configured to provide the set of control signals (e.g., control signals 306A-306N) to one or more of an onboard music engine associated with the electronic device 100 (e.g., onboard music engine 512), a user device 114, and/or any suitable computing device configured to run one or more software application which may benefit from the use of the multi-axis capacitive touch sensing system 102 (e.g., a laptop computer running a DAW configured such that one or more of the control signals 306A-306N may control one or more functionalities associated with the DAW). As described herein, the capacitive touch engine 108 may cause the provision of the first set of control signals (e.g., control signals 306A-306N) and/or data generate based on the first set control signals (e.g., musical data) via a communications network 112 and/or via one or more data I/O ports 406A-406N associated with the electronic device 100.

As set forth above, certain methods or process blocks may be skipped or omitted in some implementations. Blocks or operations may be added to some implementations. The methods and processes described herein are also not limited to any particular sequence or order, and the blocks or operations relating thereto can be performed in other sequences or orders that are appropriate. For example, described blocks or operations may be performed in an order other than that specifically disclosed, or multiple blocks or operations may be combined in a single block or state. For instance, two or more blocks or operations may be executed concurrently or with partial concurrence. The example blocks or operations may be performed in serial, in parallel, or in some other manner. For example, the order of execution of two or more blocks or operations may be scrambled relative to the order described. For instance, two or more blocks or operations may be executed concurrently or with partial concurrence. It is understood that all such variations are within the scope of the present disclosure.

It should be emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. The various features and processes described above may be used independently of one another or may be combined in various ways. All possible combinations and sub-combinations are intended to fall within the scope of this disclosure.

In addition, conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Although this disclosure has been described in terms of certain example embodiments and applications, other embodiments and applications that are apparent to those of ordinary skill in the art, including embodiments and applications that do not provide all of the benefits described herein, are also within the scope of this disclosure. The scope of the inventions is defined only by the claims, which are intended to be construed without reference to any definitions that may be explicitly or implicitly included in any incorporated-by-reference materials.

What is claimed is:

1. A system comprising:
a multi-axis capacitive touch sensing system comprising:
a set of multi-axis capacitive touch sensors;
a set of sub-controllers configured to operate the set of multi-axis capacitive touch sensors; and
a capacitive touch engine, wherein the capacitive touch engine is configured to facilitate operation of the set of sub-controllers based on execution of a sensor measurement phasing procedure, and wherein the capacitive touch engine is configured to:
execute a hybrid velocity-noise rejection procedure that comprises:
determining a first touch input has occurred with respect to a first multi-axis capacitive touch sensor of the set of multi-axis capacitive touch sensors, and
determining a velocity of the first touch input;
execute a touch input location detection procedure that comprises determining a first location of the first touch input, wherein the first location is comprised within the first multi-axis capacitive touch sensor;
generate, based on one or more of the velocity of the first touch input or the first location of the first touch input, a first control signal of a first set of control signals, wherein the first control signal is associated with a control signal type and a control signal value; and
provide the first set of control signals; and
an electronic device, wherein the multi-axis capacitive touch sensing system is comprised within a structural housing of the electronic device.

2. The system of claim 1, wherein the first multi-axis capacitive touch sensor of the set of multi-axis capacitive touch sensors comprises:
a first set of asymmetric interleaved capacitive touch bolt sensors; and
a first set of interleaved capacitive touch rejector sensors.

3. The system of claim 2, wherein the first set of asymmetric interleaved capacitive touch bolt sensors and the first set of interleaved capacitive touch rejector sensors are operated by a first sub-controller of the set of sub-controllers.

4. The system of claim 2, wherein a first subset of the first set of asymmetric interleaved capacitive touch bolt sensors is operated by a first sub-controller of the set of sub-controllers, and wherein a second subset of the first set of asymmetric interleaved capacitive touch bolt sensors is operated by a second sub-controller of the set of sub-controllers.

5. The system of claim 4, wherein facilitating the operation of the set of sub-controllers based on the execution of the sensor measurement phasing procedure causes the capacitive touch engine to:
execute a first multi-axis capacitive touch sensor scan comprising:
releasing a first bank of sub-controllers of the set of sub-controllers, wherein the first sub-controller is comprised within the first bank of sub-controllers, and wherein the first bank of sub-controllers is configured to operate a first subset of multi-axis capacitive touch sensors of the set of multi-axis capacitive touch sensors,
retrieving first sensor scan data from one or more multi-axis capacitive touch sensors of the first subset of multi-axis capacitive touch sensors, and
placing the first bank of sub-controllers into a holding status;
execute a second multi-axis capacitive touch sensor scan comprising:
releasing a second bank of sub-controllers of the set of sub-controllers, wherein the second sub-controller is comprised within the second bank of sub-controllers, and wherein the second bank of sub-controllers is configured to operate a second subset of multi-axis capacitive touch sensors of the set of multi-axis capacitive touch sensors,
retrieving second sensor scan data from one or more multi-axis capacitive touch sensors of the second subset of multi-axis capacitive touch sensors, and
placing the second bank of sub-controllers into a holding status; and
generate, based on the first sensor scan data and the second sensor scan data, a first sensor sample, wherein the first sensor sample is comprised within a set of sensor samples generated with respect to the first multi-axis capacitive touch sensor.

6. The system of claim 5, wherein determining the velocity of the first touch input during execution of the hybrid velocity-noise rejection procedure causes the capacitive touch engine to:
determine a first reading count index value, wherein the first reading count index value is associated with the first sensor sample of the set of sensor samples generated with respect to the first multi-axis capacitive touch sensor, and wherein the first reading count index value correlates to a first amount of capacitance of the first multi-axis capacitive touch sensor;
determine a second reading count index value, wherein the second reading count index value is associated with a second sensor sample of the set of sensor samples generated with respect to the first multi-axis capacitive touch sensor, wherein the second reading count index value correlates to a second amount of capacitance of the first multi-axis capacitive touch sensor;
determine, based on applying a noise rejection median filter to the set of sensor samples, whether a median value associated with the set of sensor samples satisfies a trigger threshold; and
in response to determining that the median value associated with the set of sensor samples satisfies the trigger threshold:
determine a slope value based on the first reading count index value and the second reading count index value, wherein the slope value indicates the velocity of the first touch input.

7. The system of claim 6, wherein the first reading count index value correlated to the first amount of capacitance of the first multi-axis capacitive touch sensor indicates a first proximity input.

8. The system of claim 7, wherein determining the first location of the first touch input based on the execution of the touch input location detection procedure causes the capacitive touch engine to:
determine a horizontal position index value associated with the first touch input, wherein the horizontal position index value is comprised within the first multi-axis capacitive touch sensor and wherein determining the horizontal position index value comprises:
determining a first weighted value associated with one or more asymmetric interleaved capacitive touch bolt sensors associated with a left side of the first multi-axis capacitive touch sensor, wherein the first weighted value is associated with a first amount of capacitance, and
determining a second weighted value associated with one or more asymmetric interleaved capacitive touch bolt sensors associated with a right side of the first multi-axis capacitive touch sensor, wherein the second weighted value is associated with a second amount of capacitance, and
wherein the horizontal position index value is determined based on determining a difference between the first weighted value and the second weighted value; and
determine a vertical position index value associated with the first touch input, wherein the vertical position index value is comprised within the first multi-axis capacitive touch sensor, and wherein determining the vertical position index value comprises:
determining a total pressure value associated with the first set of asymmetric interleaved capacitive touch bolt sensors and the first set of interleaved capacitive touch rejector sensors, wherein the total pressure value is associated with a total amount of capacitance associated with the first set of asymmetric interleaved capacitive touch bolt sensors and the first set of interleaved capacitive touch rejector sensors, and
determining a centroid value based on a respective amount of capacitance associated with each asymmetric interleaved capacitive touch bolt sensor of the first set of asymmetric interleaved capacitive touch bolt sensors and each interleaved capacitive touch rejector sensor of the first set of interleaved capacitive touch rejector sensors,
wherein the vertical position index value is determined based on one or more of the total pressure value, the centroid value, and a respective geometry associated with each asymmetric interleaved capacitive touch bolt sensor of the first set of asymmetric interleaved capacitive touch bolt sensors.

9. The system of claim 8, wherein the capacitive touch engine is further configured to:
determine whether the electronic device is being held by a human during the execution of the touch input location detection procedure, wherein determining whether the electronic device is being held comprises:
determining a rotation value associated with a first degree of rotation along a first axis of the electronic device,
determining a tilt value associated with a second degree of rotation along a second axis of the electronic device,
determining a yaw value associated with a third degree of rotation along a third axis of the electronic device, and
determining whether one or more of the rotation value, the tilt value, or the yaw value indicate that the electronic device is being held by a human; and
in response to determining that the electronic device is being held by a human:
configure the first set of interleaved capacitive touch rejector sensors to reject one or more touch inputs or one or more proximity inputs such, and
disregard any amount of capacitance detected with respect to the first set of interleaved capacitive touch rejector sensors the execution of the touch input location detection procedure.

10. The system of claim 9, wherein one or more control signals of the first set of control signals are generated based on one or more of the horizontal position index value of the first touch input or the vertical position index value of the first touch input.

11. The system of claim 9, wherein one or more control signals of the first set of control signals are generated based on one or more of the rotation value, the tilt value, or the yaw value.

12. The system of claim 1, wherein the capacitive touch engine is further configured to:
configure one or more control signals of the first set of control signals as a musical instrument digital interface (MIDI) signal.

13. The system of claim 12, wherein the electronic device further comprises an onboard music engine and one or more loudspeakers, wherein the onboard music engine is configured to:
generate, based on the one or more control signals configured as MIDI signals, musical data; and
cause playback of the musical data via the one or more loudspeakers.

14. The system of claim 1, wherein the multi-axis capacitive touch sensing system further comprises a capacitive touch bridge sensor comprising a set of capacitive touch bridge triggers, wherein the capacitive touch engine is further configured to:
execute the hybrid velocity-noise rejection procedure to determine a second touch input has occurred with respect to the capacitive touch bridge sensor;
execute the touch input location detection procedure to determine a second location of the second touch input, wherein the second location is comprised within the capacitive touch bridge sensor;
generate, based on one or more of a velocity of the second touch input or the second location of the second touch input, a second control signal of a second set of control signals, wherein the second control signal is associated with a control signal type and a control signal value; and
provide the second set of control signals.

15. An apparatus comprising:
a multi-axis capacitive touch sensing system comprising:
a set of multi-axis capacitive touch sensors;
a set of sub-controllers configured to operate the set of multi-axis capacitive touch sensors; and
a capacitive touch engine, wherein the capacitive touch engine is configured to facilitate operation of the set of sub-controllers based on execution of a sensor measurement phasing procedure, and wherein the capacitive touch engine is configured to:
execute a hybrid velocity-noise rejection procedure that comprises:
determining a first touch input has occurred with respect to a first multi-axis capacitive touch sensor of the set of multi-axis capacitive touch sensors, and
determining a velocity of the first touch input;
execute a touch input location detection procedure that comprises determining a first location of the first touch input, wherein the first location is comprised within the first multi-axis capacitive touch sensor;
generate, based on one or more of the velocity of the first touch input or the first location of the first touch input, a first control signal of a first set of control signals, wherein the first control signal is associated with a control signal type and a control signal value; and
provide the first set of control signals.

16. The apparatus of claim 15, wherein facilitating the operation of the set of sub-controllers based on the execution of the sensor measurement phasing procedure causes the capacitive touch engine to:
execute a first multi-axis capacitive touch sensor scan comprising:
releasing a first bank of sub-controllers of the set of sub-controllers, wherein the first bank of sub-controllers is configured to operate a first subset of multi-axis capacitive touch sensors of the set of multi-axis capacitive touch sensors,
retrieving first sensor scan data from one or more multi-axis capacitive touch sensors of the first subset of multi-axis capacitive touch sensors, and
placing the first bank of sub-controllers into a holding status;
execute a second multi-axis capacitive touch sensor scan comprising:
releasing a second bank of sub-controllers of the set of sub-controllers, wherein the second bank of sub-controllers is configured to operate a second subset of multi-axis capacitive touch sensors of the set of multi-axis capacitive touch sensors,
retrieving second sensor scan data from one or more multi-axis capacitive touch sensors of the second subset of multi-axis capacitive touch sensors, and
placing the second bank of sub-controllers into a holding status; and
generate, based on the first sensor scan data and the second sensor scan data, a first sensor sample, wherein the first sensor sample is comprised within a set of sensor samples generated with respect to the first multi-axis capacitive touch sensor.

17. The apparatus of claim 16, wherein determining the velocity of the first touch input during execution of the hybrid velocity-noise rejection procedure causes the capacitive touch engine to:
determine a first reading count index value, wherein the first reading count index value is associated with the first sensor sample of the set of sensor samples generated with respect to the first multi-axis capacitive touch sensor, and wherein the first reading count index value correlates to a first amount of capacitance of the first multi-axis capacitive touch sensor;
determine a second reading count index value, wherein the second reading count index value is associated with a second sensor sample of the set of sensor samples generated with respect to the first multi-axis capacitive touch sensor, wherein the second reading count index value correlates to a second amount of capacitance of the first multi-axis capacitive touch sensor;
determine, based on applying a noise rejection median filter to the set of sensor samples, whether a median value associated with the set of sensor samples satisfies a trigger threshold; and
in response to determining that the median value associated with the set of sensor samples satisfies the trigger threshold:
determine a slope value based on the first reading count index value and the second reading count index value, wherein the slope value indicates the velocity of the first touch input.

18. The apparatus of claim 17, wherein determining the first location of the first touch input based on the execution of the touch input location detection procedure causes the capacitive touch engine to:
determine a horizontal position index value associated with the first touch input, wherein the horizontal position index value is comprised within the first multi-axis capacitive touch sensor and wherein determining the horizontal position index value comprises:
determining a first weighted value associated with one or more asymmetric interleaved capacitive touch bolt sensors associated with a left side of the first multi-axis capacitive touch sensor, wherein the first weighted value is associated with a first amount of capacitance, and
determining a second weighted value associated with one or more asymmetric interleaved capacitive touch bolt sensors associated with a right side of the first multi-axis capacitive touch sensor, wherein the second weighted value is associated with a second amount of capacitance, and
wherein the horizontal position index value is determined based on determining a difference between the first weighted value and the second weighted value; and
determine a vertical position index value associated with the first touch input, wherein the vertical position index value is comprised within the first multi-axis capacitive touch sensor, and wherein determining the vertical position index value comprises:
determining a total pressure value associated with a first set of asymmetric interleaved capacitive touch bolt sensors and a first set of interleaved capacitive touch rejector sensors associated with the first multi-axis capacitive touch sensor, wherein the total pressure value is associated with a total amount of capacitance associated with the first set of asymmetric interleaved capacitive touch bolt sensors and the first set of interleaved capacitive touch rejector sensors, and
determining a centroid value based on a respective amount of capacitance associated with each asymmetric interleaved capacitive touch bolt sensor of the first set of asymmetric interleaved capacitive touch bolt sensors and each interleaved capacitive touch rejector sensor of the first set of interleaved capacitive touch rejector sensors,
wherein the vertical position index value is determined based on one or more of the total pressure value, the centroid value, and a respective geometry associated with each asymmetric interleaved capacitive touch bolt sensor of the first set of asymmetric interleaved capacitive touch bolt sensors.

19. A method comprising:
facilitating, by a capacitive touch engine, operation of a set of sub-controllers based on execution of a sensor measurement phasing procedure;
executing, by the capacitive touch engine, a hybrid velocity-noise rejection procedure that comprises:
determining a first touch input has occurred with respect to a first multi-axis capacitive touch sensor of a set of multi-axis capacitive touch sensors, and
determining a velocity of the first touch input;
executing, by the capacitive touch engine, a touch input location detection procedure that comprises determining a first location of the first touch input, wherein the first location is comprised within the first multi-axis capacitive touch sensor;
generating, by the capacitive touch engine and based on one or more of the velocity of the first touch input or the first location of the first touch input, a first control signal of a first set of control signals, wherein the first control signal is associated with a control signal type and a control signal value; and
providing, by the capacitive touch engine, the first set of control signals.

20. The method of claim 19, wherein determining the first location of the first touch input based on the execution of the touch input location detection procedure further comprises:
determining, by the capacitive touch engine, a horizontal position index value associated with the first touch input, wherein the horizontal position index value is comprised within the first multi-axis capacitive touch sensor and wherein determining the horizontal position index value comprises:
determining a first weighted value associated with one or more asymmetric interleaved capacitive touch bolt sensors associated with a left side of the first multi-axis capacitive touch sensor, wherein the first weighted value is associated with a first amount of capacitance, and
determining a second weighted value associated with one or more asymmetric interleaved capacitive touch bolt sensors associated with a right side of the first multi-axis capacitive touch sensor, wherein the second weighted value is associated with a second amount of capacitance, and
wherein the horizontal position index value is determined based on determining a difference between the first weighted value and the second weighted value; and
determining, by the capacitive touch engine, a vertical position index value associated with the first touch input, wherein the vertical position index value is comprised within the first multi-axis capacitive touch sensor, and wherein determining the vertical position index value comprises:
determining a total pressure value associated with a first set of asymmetric interleaved capacitive touch bolt sensors and a first set of interleaved capacitive touch rejector sensors associated with the first multi-axis capacitive touch sensor, wherein the total pressure value is associated with a total amount of capacitance associated with the first set of asymmetric interleaved capacitive touch bolt sensors and the first set of interleaved capacitive touch rejector sensors, and
determining a centroid value based on a respective amount of capacitance associated with each asymmetric interleaved capacitive touch bolt sensor of the first set of asymmetric interleaved capacitive touch bolt sensors and each interleaved capacitive touch rejector sensor of the first set of interleaved capacitive touch rejector sensors,
wherein the vertical position index value is determined based on one or more of the total pressure value, the centroid value, and a respective geometry associated with each asymmetric interleaved capacitive touch bolt sensor of the first set of asymmetric interleaved capacitive touch bolt sensors.
